(19) United States
(12) Patent Application Publication
(10) Pub. No.: US 2026/0224422 A1
(43) Pub. Date: Aug. 6, 2026

(54) Bobotic Care Bed

(71) Applicant: Zuoliang Chen, San Francisco, CA (US)

(72) Inventor: Zuoliang Chen, San Francisco, CA (US)

(21) Appl. No.: 19/152,944

(22) PCT Filed: Apr. 22, 2024
(86) PCT No.: PCT/US2024/025728

§ 371 Date: Aug. 1, 2025

(51) Int. Cl. A61G 7/16; A61G 5/00; A61G 5/10; A61G 5/12; A61G 7/015; A61G 7/018; A61G 7/02

(52) U.S. Cl. CPC A61G 7/165; A61G 5/006; A61G 5/1002; A61G 5/125; A61G 7/015; A61G 7/018; A61G 7/02

(57) ABSTRACT

A robotic care bed mainly comprises a bed body and a mobile body, the bed body comprises a stationary part and two rotatable sides that form an opening in the middle portion of the bed body to accommodate the mobile body, the mobile body can be automatically locked or unlocked with the bed body by electromagnet devices, the mobile body has double plate high/low and turn over structure to perform the necessary high/low and turn over functions, the mobile body can be automatically converted into a wheelchair that having features of auto armrest setup and auto charging, the two rotatable sides can be rotated sideward or upward to make rooms for the wheelchair to be set up and to move out or return to the bed body opening easily, the mobile body also equipped with an auto bidet system.

### FIELD OF INVENTION

The present invention is related to a robotic care bed that enables the elderly or disabled people to take care of themselves without assistance from caregivers. The robotic care bed mainly comprises a bed body and a mobile body, the bed body comprises a stationary part and two rotatable sides that form an opening in the middle portion of the bed body to accommodate the mobile body, the mobile body can be automatically locked or unlocked with the bed body by electromagnet devices, the mobile body has double plate high/low and turn over structure to perform the necessary high/low and turn over functions, the mobile body can be automatically converted into a wheelchair that having features of auto armrest and auto charging, the two rotatable sides can be rotated sideward or upward to make rooms for the armrests of the wheelchair to be set up automatically, and for the wheelchair to move out and return to bed body opening easily, the mobile body also equipped with an auto bidet system for easy defecation, urination and cleaning.

### BACKGROUND

We are entering an aging society, rising demand and short caregiver supply is a big problem faced by the elderly, disabled people (patients) and their family members.

Generally, a patient's daily needs can be categorized as immediate needs and scheduled needs, immediate needs are those that cannot be arranged in advance and have to be met immediately, such as using toilet, cleaning after using toilet, turning over safely in bed, high/low in bed, out of bed activities, and returning to bed, usually a long-term caregiver is required to offer help to meet these immediate needs. Scheduled needs are those that can be arranged in advance, which is mainly to deal with various housework such as cleaning, laundry, cooking, assisting with bathing and massage, etc. usually such scheduled needs can be done by hourly caregivers, and long-term caregiver is not required.

So, we can see that if patients can meet their own immediate needs, long-term caregivers will not be required, and demand for caregivers can be reduced substantially. However, although there are many care equipment such as electric wheelchair, electric care bed, transfer machine etc. have been invented, these equipment can only help patients to meet only one or two of the above mentioned immediate needs instead of all of them, therefore long-term caregivers are still needed to help patients to meet the other immediate needs, the purposes of these care equipments are to make job easier for caregivers rather than helping patients to take care of themselves and become independent.

### SUMMARY OF INVENTION

Many different types of robotic nursing beds have been invented, some of them can also be converted into a wheelchair, U.S. Pat. No. 9,295,596 “Combined Nursing Bed” invented by Hanzhong He, dated Mar. 29, 2016 disclosed a combined type nursing bed, the middle portion of the nursing bed can be converted into a wheelchair, this invention has the following shortcomings:
1. The wheelchair is not powered by electricity, a caregiver is required to set up the wheelchair, move it out and return it to bed.
2. It has no turn over feature, the toilet has no cleaning means and the fecal bucket has no lid for odor sealing.
3. It provides no means to lock the wheelchair to the bed body when combine the wheelchair to bed body to form a nursing bed, so it is unsecured and unsafe when used as a nursing bed.

In order to solve the defecation and urination problem, many different types of toilet or bidet system for nursing bed have been invented as well, however, these inventions have the following shortcomings:
1. They are usually too big to fit under a wheelchair seat, making it impossible to convert a nursing bed into a wheelchair that having auto toilet system.
2. Patients may not be able to position to the toilet hole properly, that will cause mess and lots of cleaning afterward.
3. Not able to automatically put a lid on the fecal bucket to prevent odor.
4. Because user have a weight on the toilet hole, such inventions may not be able to reposition the toilet seat back to toilet hole properly.
5. Patients can only defecate or urinate in bed, making their sleeping area very smelly.

Therefore, in order to help patients to regain their independence and reduce the need of caregivers substantially, a robotic care bed that enables patients to meet all of the above mentioned immediate needs without any assistance from caregiver is very much desirable.

The present invention of robotic care bed enables patients to meet all of the above mentioned immediate needs, it has the following advantages:
1. Auto bidet system to meet the immediate need of urination and defecation.
2. Auto washing, drying and odor sealing to meet the immediate need of cleaning after urination or defecation, and odor prevention.
3. Auto shoulder line turn over to meet the immediate need of turn over safely and comfortably in bed.
4. Auto high/low to meet the immediate need of high/low in bed.
5. Auto wheelchair conversion to meet the immediate need of out of bed activities.
6. Easy or auto returning to bed and auto charging to meet the immediate need of returning to bed.

### BRIEF DESCRIPTION OF DRAWINGS

FIG. 1 illustrates the prospective view of robotic care bed.

FIG. 2 illustrates the top view of bed body.

FIG. 3 illustrates the top view of mobile body.

FIG. 4 illustrates right and left rotatable sides rotate to the side, mobile body is converted into a wheelchair and move out.

FIG. 5 illustrates wheelchair return to bed body opening.

FIG. 6 illustrates wheelchair before automatic armrest is set up.

FIG. 7 illustrates wheelchair after automatic armrest is set up.

FIG. 8 illustrates the top view of back base plate.

FIG. 9 illustrates the top view of back turn plate.

FIG. 10 illustrates the bottom view of back turn plate.

FIG. 11 illustrates the cross section front view of back plate.

FIG. 12 illustrates the top view of thigh base plate.

FIG. 13 illustrates the top view of thigh turn plate.

FIG. 14 illustrates the bottom view of thigh turn plate.

FIG. 15 illustrates the cross section front view of thigh plate.

FIG. 16 illustrates the cross section front view of back plate connected to back plate high/low and turn over device.

FIG. 17 illustrates the cross section front view showing back turn plate is turned to the right side.

FIG. 18 illustrates the side view of mobile body in flat position (without mattress pads, armrest and bidet system, with partial cross section view).

FIG. 19 illustrates the side view of mobile body showing both of back turn plate and thigh turn plate are turn to the right (without mattress pads, armrest and bidet system with partial cross section view).

FIG. 20 illustrates the side view of mobile body converted into a wheelchair.

FIG. 21 illustrates the front view of robotic care bed with blanket blocking roller.

FIG. 22 illustrates the front view of bidet system.

FIG. 23 illustrates the side view of bidet system.

FIG. 24 illustrates the cross section front view of bidet system.

FIG. 25 illustrates the cross section side view of bidet system.

FIG. 26 illustrates bidet seat is moved out of bidet hole.

FIG. 27 illustrates bidet seat turning to the side while fecal bag holder moving down.

FIG. 28 illustrates bidet seat turn to the side and fecal bag holder is moved down to its lowest position.

FIG. 29 illustrates bidet seat stay at the side and fecal bag holder move up to bidet hole.

FIG. 30 illustrates cleaning device move in to do the cleaning.

FIG. 31 illustrates that after cleaning, cleaning device retract, bidet seat stay at the side and fecal bag holder is moved down to its lowest position again.

FIG. 32 illustrates bidet seat turning upward and fecal bag holder moving up at the same time.

FIG. 33 illustrates bidet seat return to the bottom of bidet hole.

FIG. 34 illustrates bidet seat and fecal bag holder are moved up to reposition.

FIG. 35 illustrates the front view of incontinence bidet system.

FIG. 36 illustrates the side view of incontinence bidet system.

FIG. 37 illustrates the cross section front view of incontinence bidet system.

FIG. 38 illustrates a fecal incontinence situation.

FIG. 39 illustrates fecal sensor detect the feces and then open fecal tube cover, and lower incontinence fecal bag holder.

FIG. 40 illustrates that after defecation, washing and drying device wash and dry the private part of patient and bidet seat pad.

FIG. 41 illustrates that after washing and drying, incontinence fecal bag holder is moved up and push incontinence bidet seat to reposition.

FIG. 42 illustrates the cross section view of fecal bag holder ring.

FIG. 43 illustrates the front view of urine guard.

FIG. 44 illustrates the side view of urine guard.

FIG. 45 illustrates the side view of urine guard installed in the edge of bidet hole.

### REFERENCE NUMERALS IN DRAWINGS

1 Robotic care bed
11 Bed body
111 Stationary part
1111 Stationary head
1112 Right stationary side
1113 Left stationary side
1121 Right rotatable side
1122 Left rotatable side
1123 Sideward hinge
1124 Wheeled leg
1125 Sideward rotating device
114 Bed body mattress pad
12 Control system
13 Auto charging device
14 Return guiding system
141 Return guiding rail
142 Return guiding laser pen
1421 Return guiding laser beam
2 Mobile body
21 Wheelchair
211 Mobile body wheel
22 Rechargeable battery
23 Mobile body mattress pad
24 Plate hinge
25 Rotatable armrest
251 Armrest rotatable arm
252 Armrest bar
253 Armrest rotating device
254 Armrest lock
255 Armrest locking piece
26 Mobile body chamber
27 Calf and feet plate high/low device
271 Calf plate linear actuator
2711 Calf plate joint swivel
272 Feet plate linear actuator
2721 Feet plate joint swivel
2722 Feet plate linkage
28 Blanket blocking roller
281 Roller spring
282 Roller fabric
3 Back plate
31 Back base plate
311 Back base plate window
3121 Right back base plate electromagnet
3122 Left back base plate electromagnet
32 Back turn plate
3211 Right back turn plate
3212 Left back turn plate
3221 Right center back turn plate
3222 Left center back turn plate
3231 Right back turn plate magnet locking piece
3232 Left back turn plate magnet locking piece
324 Back turn plate hinge
331 Right back plate linear actuator
332 Left back plate linear actuator
34 Back plate bottom multi direction joint swivel
35 Back plate top multi direction joint swivel
36 Back plate linear actuator base
37 Back plate magnet locking piece
38 Back plate electromagnet
39 Back plate high/low and turn over device
4 Thigh plate
41 Thigh base plate
411 Thigh base plate window
4121 Right thigh base plate electromagnet
4122 Left thigh base plate electromagnet
42 Thigh turn plate
4211 Right thigh turn plate
4212 Left thigh turn plate
4221 Right Center thigh turn plate
4222 Left Center thigh turn plate
4231 Right thigh turn plate magnet locking piece
4232 Left thigh turn plate magnet locking piece
424 Thigh turn plate hinge
431 Right thigh plate linear actuator
432 Left thigh plate linear actuator
44 Thigh plate bottom multi direction joint swivel
45 Thigh plate top multi direction joint swivel
46 Thigh plate linear actuator base
47 Bidet hole
48 Thigh plate high/low and turn over device
49 Thigh plate mattress pad
5 Calf plate
51 Calf plate magnet locking piece
52 Calf plate electromagnet
6 Feet plate
61 Feet plate magnet locking piece
62 Feet plate electromagnet
7 Bidet system
71 Bidet seat
711 Bidet seat plate
712 Bidet seat screw jack
713 Bidet seat turning device
714 Bidet seat pad
72 Fecal bag holder
721 Fecal bag holder ring
7211 Fecal bag holder ring mounting groove
7212 Fecal bag holder ring water guard
7213 Cleaning tube opening
73 Fecal bag holder screw jack
731 Fecal bag holder screw jack motor
74 Fecal bag
741 Fecal bag tray
75 Cleaning device
76 Water tank
8 Incontinence bidet system
81 Incontinence bidet seat
811 Incontinence bidet seat plate
812 Incontinence bidet seat pad
813 Incontinence fecal hole
82 Inner incontinence fecal bag holder
821 Fecal tube
822 Fecal tube cover
823 Fecal tube cover opening device
824 Fecal sensor
825 Inner incontinence fecal bag
826 Inner incontinence fecal bag fastener
827 Inner incontinence fecal bag holder screw jack
8271 Inner incontinence fecal bag holder screw jack motor
83 Outer incontinence fecal bag holder
831 Outer incontinence fecal bag
832 Outer incontinence fecal bag fastener
84 Incontinence fecal bag tray
85 Incontinence cleaning device
86 Incontinence water tank
87 Butt retainer
871 Retainer fabric
872 Retainer bottom opening
873 Retainer fastener
874 Retainer cleaning hole
9 Urine guard
91 Bottom urine blocking plate
92 Top urine blocking plate
93 Stem
100 Feces

### DESCRIPTION OF PREFERRED EMBODIMENTS

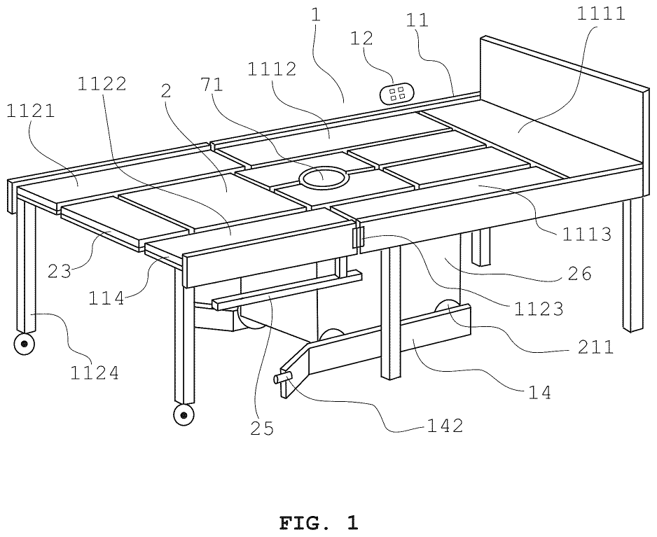

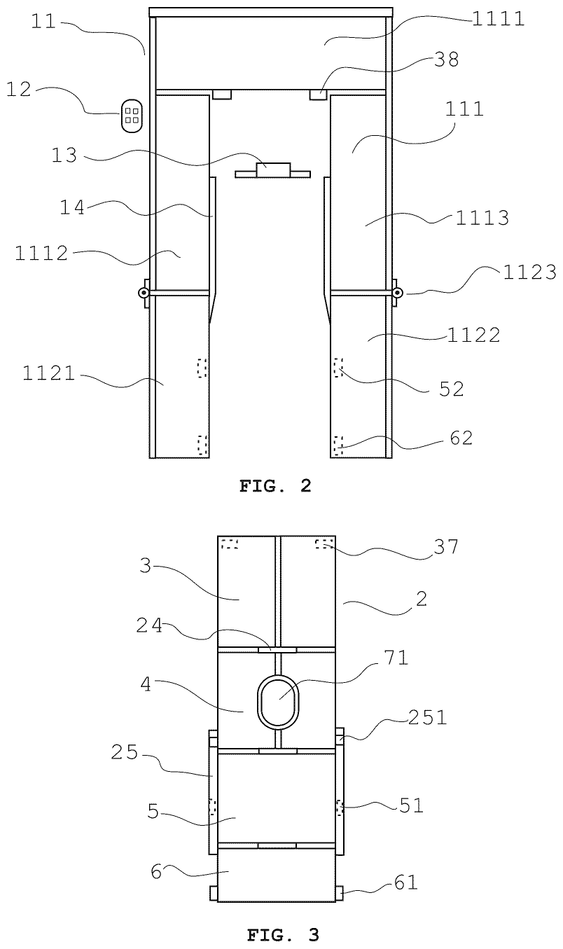

As illustrated in FIG. 1, FIG. 2 and FIG. 3, robotic care bed 1 comprises a bed body 11, a mobile body 2, and a control system 12, bed body 11 further comprises a stationary part 111, a right rotatable side 1121, a left rotatable side 1122, an auto charging device 13, and a return guiding system 14, stationary part 111 further comprises a stationary head 1111, a right stationary side 1112, and a left stationary side 1113.

As illustrated in FIG. 1, FIG. 2 and FIG. 3, one end of right rotatable side 1121 is jointed to right stationary side 1112 with a first sideward hinge 1123, another end of right rotatable side 1121 has a first wheeled leg 1124, such that right rotatable side 1121 can be rotated to the right by a first sideward rotating device 1125 (not shown), one end of left rotatable side 1122 is jointed to left stationary side 1113 with a second sideward hinge 1123, another end of left rotatable side 1122 has a second wheeled leg 1124, such that left rotatable side 1122 can be rotated to the left by a second sideward rotating device 1125 (not shown), stationary part 111, right rotatable side 1121 and left rotatable side 1122 form an bed body opening in the middle portion of bed body 11 to accommodate mobile body 2, mobile body 2 can be automatically locked or unlocked with bed body 11 by electromagnet means, control system 12 is connected to robotic care bed 1 via wired or wireless means and is capable of receiving orders and instruct robotic care bed 1 to act accordingly, auto charging device 13 is capable of automatically charging mobile body 2 when it is returned to bed body opening, return guiding system 14 is capable of guiding wheelchair 21 return to bed body opening easily, bed body 11 is covered with bed body mattress pad 114.

Mobile body 2 is the most important part of the present invention, it can be automatically converted into a wheelchair 21, it has a double plate high/low and turn over structure, an auto bidet system, an auto armrest system, and an auto charging system.

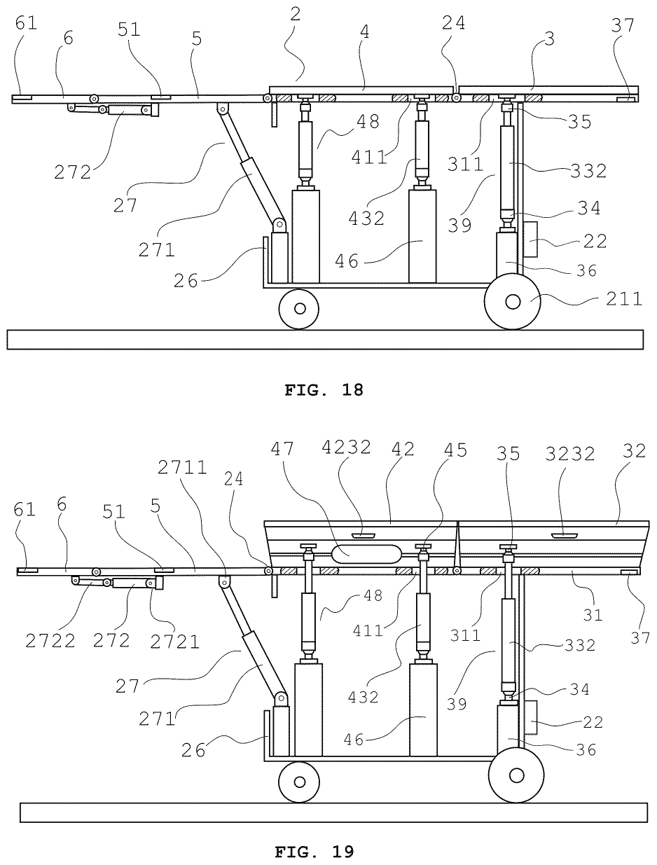

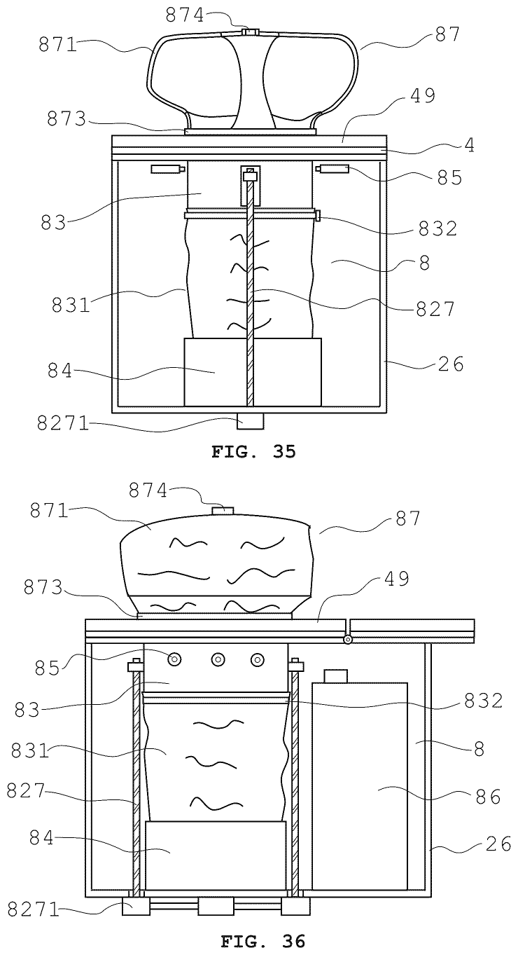

As illustrated in FIG. 3 and FIG. 18, mobile body 2 comprises a back plate 3, a thigh plate 4, a calf plate 5, a feet plate 6, a back plate high/low and turn over device 39, a thigh plate high/low and turn over device 48, a calf and feet plate high/low device 27, a mobile body chamber 26, a bidet system 7 (shown in FIG. 22) or an incontinence bidet system 8 (shown in FIG. 35), four mobile body wheels 211, and a rechargeable battery 22, the bottom edge of back plate 3 is jointed to the top edge of thigh plate 4 with a first plate hinge 24, the bottom edge of thigh plate 4 is jointed to the top edge of calf plate 5 with a second plate hinge 24, the bottom edge of calf plate 5 is jointed to the top edge of feet plate 6 with a third plate hinge 24, back plate 3 is operated by back plate high/low and turn over device 39, thigh plate 4 is operated by thigh plate high/low and turn over device 48, calf plate 5 and feet plate 6 are operated by calf and feet plate high/low device 27, thigh plate 4 is mounted on top of mobile body chamber 26, a bidet hole 47 is opened in the middle portion of thigh plate 4 and chamber 26 to accommodate the bidet seat of bidet system 7 or incontinence bidet system 8, back plate high/low and turn over device 39, thigh plate high/low and turn over device 48, and bidet system 7 or incontinence bidet system 8 are housed in mobile body chamber 26, mobile body chamber 26 is mounted on mobile body wheels 211, rechargeable battery 22 is mounted in mobile body chamber 26 and is capable of providing power to all the electric parts in mobile body 2, mobile body 2 is covered with mobile body mattress pad 23, when two of mobile body wheels 211 are electric motor wheels, mobile body 2 can be driven by electric power.

FIG. 4 illustrates right rotatable side 1121 and left rotatable side 1122 are rotated to the side, mobile body 2 is converted into wheelchair 21 and move out of bed body opening.

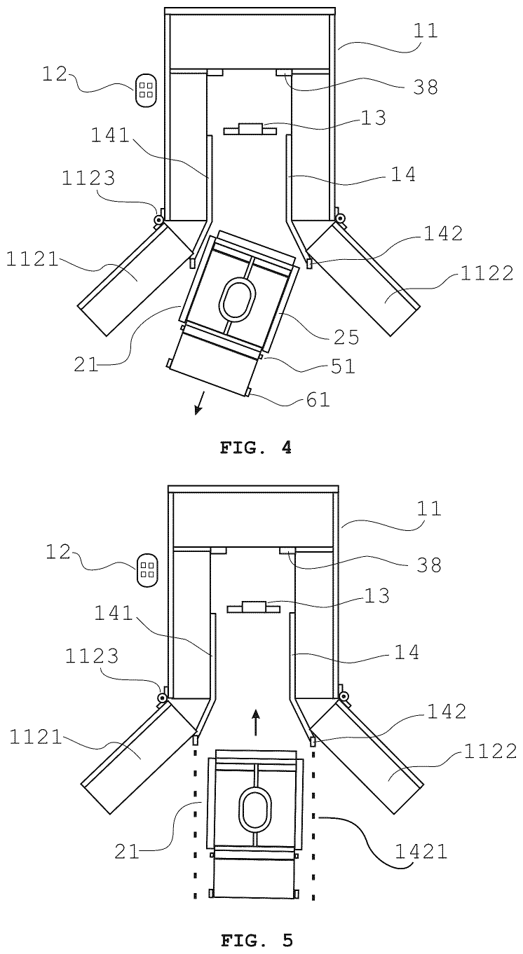

FIG. 5 illustrates wheelchair 21 use return guiding system 14 to return to bed body opening, return guiding system 14 comprises a return guiding rail 141 and two return guiding laser pens 142, return guiding rail 141 is installed along bed body opening and has a wide open entrance, each side of the entrance is affixed with a return guiding laser pen 142 that can generates visible laser beams 1421 to indicate the location of return rail entrance to a wheelchair user, such that wheelchair user can follow laser beams 1421 to return to bed body opening easily.

Armrest is very important for the safety of wheelchair user, since a patient who use robotic care bed 1 is unable to setup armrest manually when mobile body 2 is converted to wheelchair 21, the present invention provides a method to set up armrest automatically.

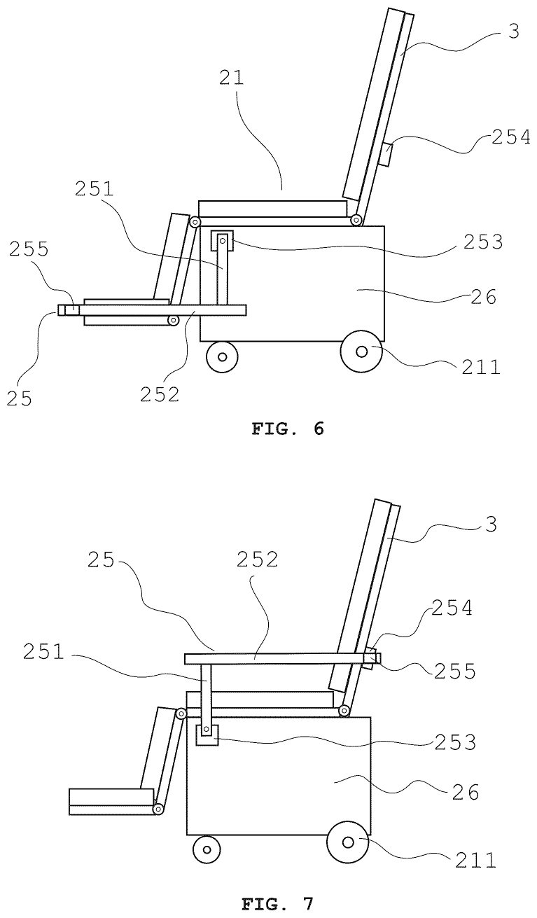

As illustrated in FIG. 6 and FIG. 7, a first rotatable armrest 25 is mounted on the right side of mobile body chamber 26, a second rotatable armrest 25 is mounted on the left side of mobile body chamber 26, rotatable armrest 25 comprises a rotatable arm 251, an armrest bar 252, and an armrest rotating device 253, one end of rotatable arm 251 is connected to armrest bar 252 perpendicularly, another end is connected to armrest rotating device 253, armrest rotating device 253 is installed on the side of mobile body chamber 26, an armrest locking piece 255 is affixed to the long end of armrest bar 252, an armrest lock 254 is affixed to the edge of base plate 3, in a location corresponding to armrest locking piece 255 when mobile body 2 is converted into wheelchair 21, when mobile body 2 is in flat position, armrest bar 252 is held under thigh plate 4 by armrest rotatable arm 251, when mobile body 2 is converted into wheelchair 21, rotatable arm 251 is rotated upward by armrest rotating device 253, making armrest bar 252 rotated upward to a position level with thigh plate 4, and armrest locking piece 255 is rotated to the location of armrest lock 254, such that armrest locking piece 255 can be locked with armrest lock 254, such that armrests 25 can be automatically secured to wheelchair 21, armrest lock 254 can be electromagnet lock or mechanical lock.

In order for rotatable armrest to be set up automatically, sideward hinges 1123 must be positioned closer to stationary head 1111 than armrest rotatable arms 251, such that when right rotatable sides 1121 and left rotatable side 1122 are rotated to the side, armrest rotatable arm 251 has room to be rotated upward to setup armrest 25 automatically.

As we can see from FIG. 1, FIG. 2, FIG. 3 and FIG. 4, bed body 11 and mobile body 2 are two separated parts, they are locked together to form robotic care bed 1, in other inventions, there is no such locking or the locking is manually done with mechanical means, that means caregiver is required to manually lock or unlock mobile body 2 with bed body 11, the present invention use electromagnet means to do the locking and unlocking automatically.

As illustrated in FIG. 2 and FIG. 4, in bed body 11, at least one back plate electromagnet 38 is affixed to the inner edge of stationary head 1111, a first calf plate electromagnet 52 is affixed to the inner edge of right rotatable side 1121, a second calf plate electromagnet 52 is affixed to the inner edge of left rotatable side 1122, a first feet plate electromagnet 62 is affixed to the inner edge of right rotatable side 1121, a second feet plate electromagnet 62 is affixed to the inner edge of left rotatable side 1122.

As illustrated in FIG. 3 and FIG. 18, in mobile body 2, there is at least one back plate magnet locking piece 37 is affixed to the edge of back plate 3, in location corresponding to back plate electromagnet 38 when mobile body 2 is parked in bed body opening and laid flat, such that when mobile body 2 is laid flat in bed body opening, back plate 3 move downward, causing back plate magnet locking piece 37 move to the location of back plate electromagnet 38, such that back plate magnet locking piece 37 can be locked or unlocked with back plate electromagnet 38, making back plate 3 to be locked or unlocked with bed body 11.

As illustrated in FIG. 3, FIG. 4 and FIG. 18, in mobile body 2, there is a first calf plate magnet locking piece 51 affixed to the right edge of calf plate 5, in location corresponding to first calf plate electromagnet 52, there is a second calf plate magnet locking piece 51 affixed to the left edge of calf plate 5, in location corresponding to second calf plate electromagnet 52, there is a first feet plate magnet locking piece 61 affixed to the right edge of feet plate 6, in location corresponding to first feet plate electromagnet 62, there is a second feet plate magnet locking piece 61 affixed to the left edge of feet plate 6, in location corresponding to second feet plate electromagnet 62, such that when mobile body 2 is laid flat in bed body opening, calf plate 5 and feet plate 6 move upward, causing calf plate magnet locking piece 51 and feet plate magnet locking piece 61 move to the locations of calf plate electromagnet 52 and feet plate electromagnet 62, such that calf plate magnet locking piece 51 can be locked or unlocked with calf plate electromagnet 52, and feet plate magnet locking piece 61 can be locked or unlocked with feet plate electromagnet 62, making calf plate 5 and feet plate 6 to be locked or unlocked with right rotatable side 1121 and left rotatable side 1122, such that mobile body 2 can be locked or unlocked with bed body 11 automatically.

The high/low and turn over feature of a care bed is very important for patients, traditional care beds use a single plate structure for this features, since they have to use one set of mechanism for high/low, and use another set of mechanism for turning over, that makes the care bed structure very complicated and bulky, and not suitable for converting into a wheelchair, also, because of the mechanical limitation, traditional care beds can only turn over around the middle line of the care bed, since people actually turn over around their shoulder instead of around their spine, the traditional turn over method having many problems such as small turning angle, uncomfortable turning, unable to turn over, potential injury, etc.

Unlike traditional care bed that use a single plate structure, the present invention use a double plate structure, in which back plat 3 is constructed with a base plate 31 and a turn plate 32, thigh plate 4 is constructed with a base plate 41 and a turn plate 42, the whole or partial of turn plate can be locked or unlocked with base plate by electromagnet means, both high/low feature and turn over feature are performed by the same back plate high/low and turn over device 39 and thigh plate high/low and turn over device 48, such that mobile body 2 can be easily switched from high/low feature to turn over feature by locking turn plates with base plates or unlocking turn plates with base plates.

FIG. 8 illustrates the top view of back base plate 31, in which a right back base plate electromagnet 3121 is affixed to the right side of back base plate 31, a left back base plate electromagnet 3122 is affixed to the left side of back base plate 31, a back base plate window 311 is opened in back base plate 31.

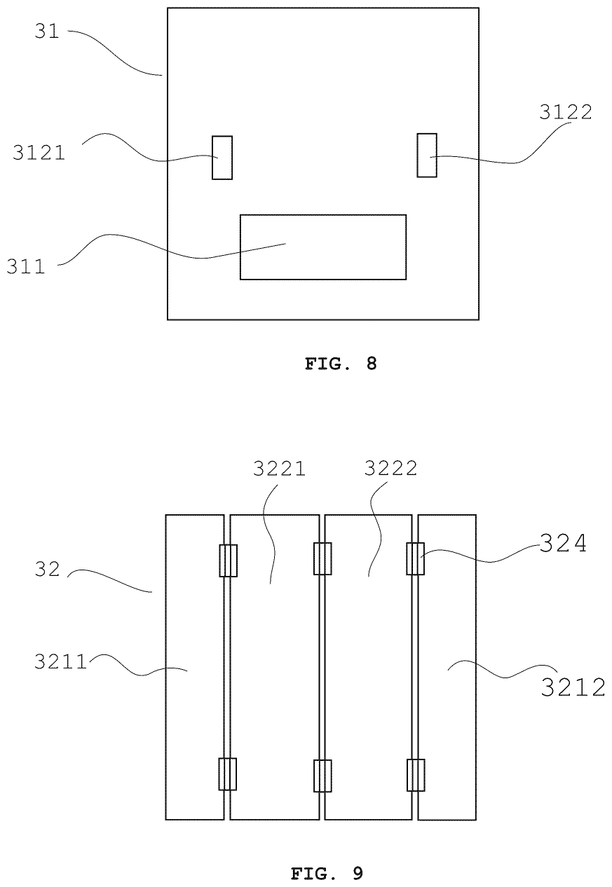

FIG. 9 illustrates the top view of back turn plate 32, in which back turn plate 32 comprises a right back turn plate 3211, a left back turn plate 3212, a right center back turn plate 3221, a left center back turn plate 3222, they are jointed together by a plurality of back turn plate hinges 324.

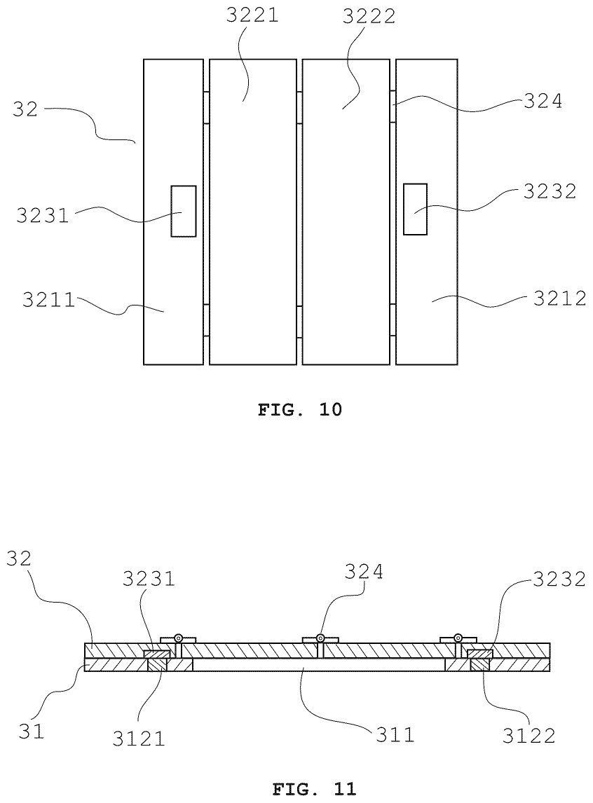

FIG. 10 illustrates the bottom view of back turn plate 32, in which a right back turn plate magnet locking piece 3231 is affixed to the bottom of right back turn plate 3211, in a location corresponding to right back base plate electromagnet 3121, a left back turn plate magnet locking piece 3232 is affixed to the bottom of left back turn plate 3212, in a location corresponding to left back base plate electromagnet 3122.

FIG. 11 illustrates the front view of back plate 3, in which back turn plate 32 is placed on top of back base plate 31, with right back turn plate magnet locking piece 3231 locate above right back turn plate electromagnet 3121, and with left back turn plate magnet locking piece 3232 locate above left back turn plate electromagnet 3122.

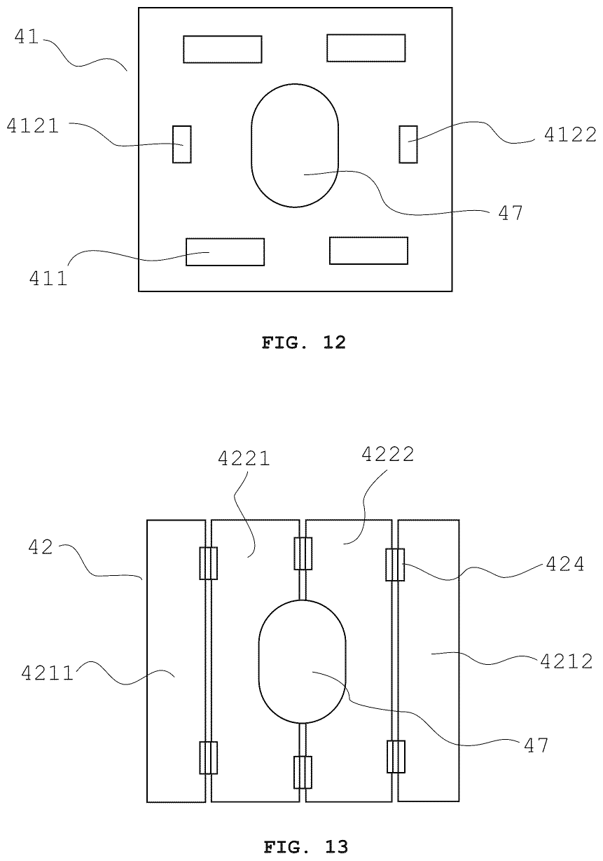

FIG. 12 illustrates the top view of thigh base plate 41, in which a right thigh base plate electromagnet 4121 is affixed to the right side of thigh base plate 41, a left thigh base plate electromagnet 4122 is affixed to the left side of thigh base plate 41, four thigh base plate windows 411 are opened in thigh base plate 41, a bidet seat hole 47 is opened in the middle portion of thigh base pale 41.

FIG. 13 illustrates the top view of thigh turn plate 42, in which thigh turn plate 42 comprises a right thigh turn plate 4211, a left thigh turn plate 4212, a right center thigh turn plate 4221, a left center thigh turn plate 4222, they are jointed together by a plurality of thigh turn plate hinges 424, a bidet hole 47 is opened in the middle portion of thigh turn pale 42.

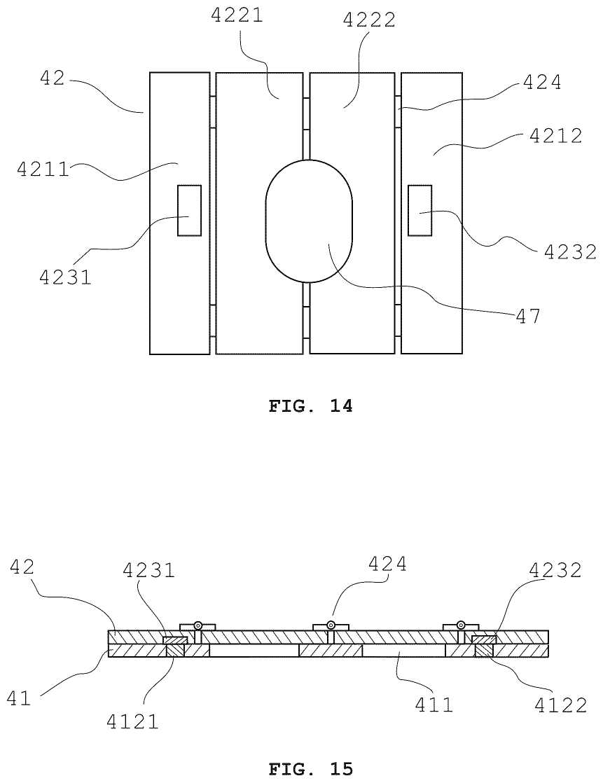

FIG. 14 illustrates the bottom view of thigh turn plate 42, a right thigh turn plate magnet locking piece 4231 is affixed to the bottom of right thigh turn plate 4211, in a location corresponding to right thigh base plate electromagnet 4121, a left thigh turn plate magnet locking piece 4232 is affixed to the bottom of left thigh turn plate 4212, in a location corresponding to left thigh base plate electromagnet 4122.

FIG. 15 illustrates the front view of thigh plate 4, in which thigh turn plate 42 is placed on top of thigh base plate 41, with right thigh turn plate magnet locking piece 4231 locate above right thigh turn plate electromagnet 4121, and left thigh turn plate magnet locking piece 4232 locate above left thigh turn plate electromagnet 4122.

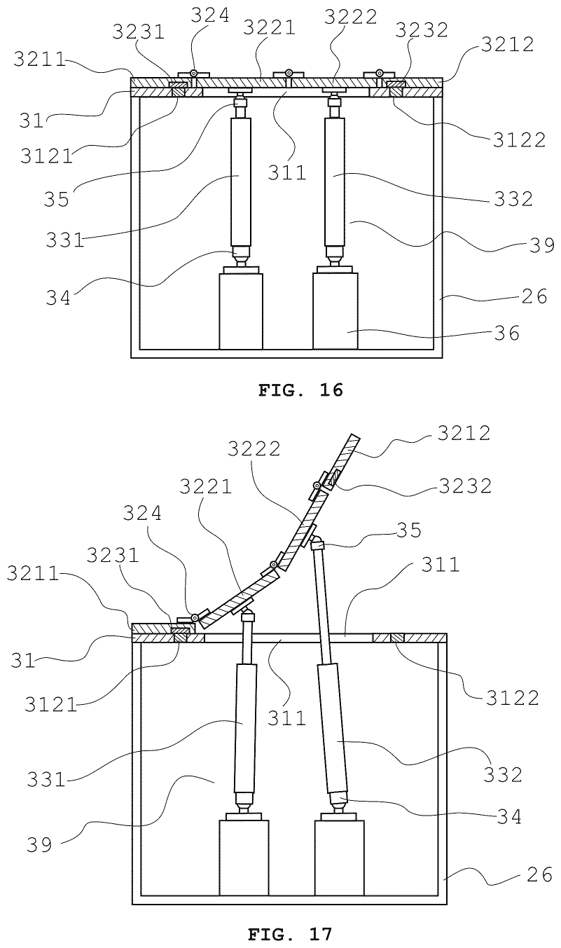

FIG. 16 illustrates the cross section front view of back plate 3 and back plate high/low and turn over device 39, in which back plate 3 is in a flat position.

As illustrated in FIG. 16, back plate high/low and turn over device 39 comprises a right back plate linear actuator 331, a left back plate linear actuator 332, two bottom multi direction joint swivels 34, two top multi direction joint swivels 35, and two back plate linear actuator base 36, the bottom of right back plate linear actuator 331 is affixed to a first back plate linear actuator base 36 via a first bottom multi direction joint swivel 34, the extension tube of right back plate linear actuator 331 is extended through back base plate window 311 and affixed to the bottom of right center turn plate 3221 via a first top multi direction joint swivel 35, the bottom of left back plate linear actuator 332 is affixed to a second back plate linear actuator base 36 via a second bottom multi direction joint swivel 34, the extension tube of left back plate linear actuator 332 is extended through back base plate window 311 and affixed to the bottom of left center turn plate 3222 via a second top multi direction joint swivel 35, when right back base plate electromagnet 3121 is electrified, it will lock with right back turn plate magnet locking piece 3231, when left back base plate electromagnet 3122 is electrified, it will lock with left back turn plate magnet locking piece 3232, such that back turn plate 32 can be locked with back base plate 31 into one piece when right back base plate electromagnet 3121 and left back base plate electromagnet 3122 are electrified.

FIG. 17 illustrates how back turn plate 32 is turn over to the right, before turn over, back plate 3 must be locked with bed body 11, when control system 12 receives an order to turn over to the right, left back turn plate 3212 is unlocked from back base plate 31, at the same time, controlled by a preset program, left back plate linear actuator 332 extend at a fast speed to a long distance, and right back linear actuator 331 extend at a slow speed to a short distance, making the left portion of back turn plate 32 to turn around back turn plate hinge 324 that join right back turn plate 3211 and right back center plate 3221 to a desired angle, since left center turn plate 3222 and right center turn plate 3221 are joined by turn plate hinge 324, so that the turn over angle and curve can be adjusted by adjusting the extended distance of right back linear actuator 331 and left back linear actuator 332, such that the turn over feature of robotic care bed 1 can be adjusted to match the upper body shape of a particular patient for safe and comfortable turn over.

FIG. 18 illustrates the side view of mobile body 2 in flat position (without mattress pads, armrest and bidet system, with partial cross section view).

FIG. 19 illustrates the side view of mobile body 2 (without mattress pads, armrest and bidet system, with partial cross section view), showing both back turn plate 32 and thigh turn plate 42 are turn over to the right.

As illustrated in FIG. 18, thigh plate high/low and turn over device 48 comprises two right thigh plate linear actuator 431 (not shown), two left thigh plate linear actuator 432, four bottom multi direction joint swivels 44, four top multi direction joint swivels 45, and four thigh plate linear actuator base 46, the connection of thigh plate high/low and turn over device 48 to thigh turn plate 42 is similar to that of back plate high/low and turn over device 39 to back turn plate 32.

As illustrated in FIG. 19, the turn over method of thigh turn plate 42 is similar to that of back turn plate 32, and done by two right thigh liner actuators 431 and two left thigh linear actuators 432, in the present invention, back turn plate 32 and thigh turn plate 42 are independent from each other, so that they can be turn to different angle and curve to better conform to a particular patient's upper body and lower body shape.

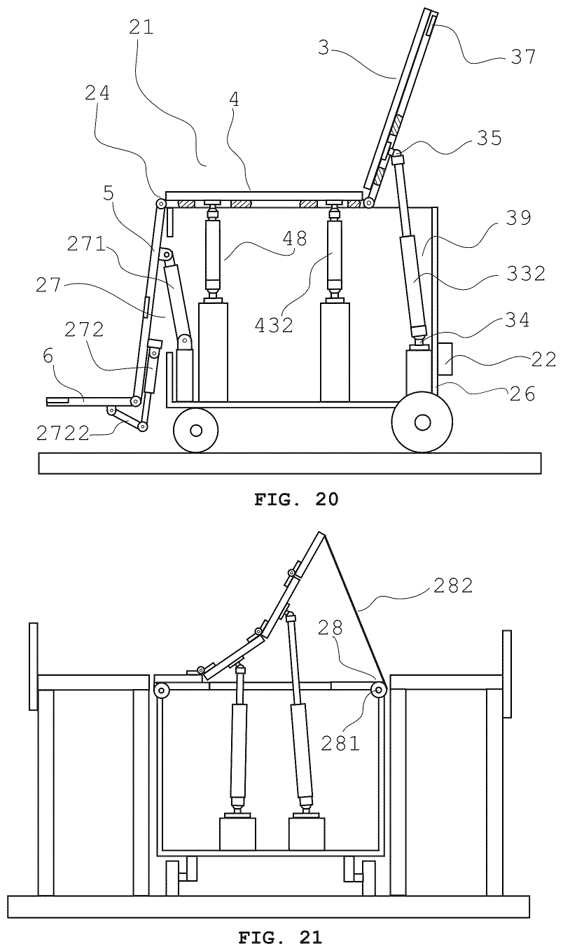

FIG. 20 illustrates how back plate 3 is raised up and how mobile body 2 is converted into wheelchair 21.

As illustrated in FIG. 20, when back plate 3 need to be raised up, first back turn plate 32 must be locked with back base plate 31 into one piece, then back plate 3 is unlocked from stationary part 111, such that when right back plate linear actuator 331 and left back plate linear actuator 332 extend at the same speed, base plate 3 can rotate around plate hinge 225 that connect back base plate 31 and thigh base plate 41 to a desired angle.

As illustrated in FIG. 20, when back plate 3 is raised by back plate high/low and turn over device 39, and calf plate 5 and feet plate 6 are lowered by calf and feet plate high/low device 27, mobile body 2 is converted into wheelchair 21.

To convert mobile body 2 into a wheelchair, calf plate 5 and feet plate 6 must be lowered, traditional high/low method require linear actuators to be installed inside mobile body chamber 26 and a long linkage is needed, this method will occupy valuable space in the mobile body chamber 26, and the strength may not be strong enough.

The present invention provides a new method to solve this problem, as illustrated in FIG. 18, FIG. 19 and FIG. 20, calf plate and feet plate high/low device 27 comprises a calf plate linear actuator 271, two calf plate joint swivels 2711, a feet plate linear actuator 272, two feet plate joint swivel 2721, and a feet plate linkage 2722, the base of calf plate linear actuator 271 is affixed to the front part of mobile body cabinet 26 with a first calf plate joint swivel 2711, the extension tube of calf plate linear actuator 271 is affixed to the bottom of calf plate with a second calf plate joint swivel 2711, the base of feet plate linear actuator 272 is affixed to the bottom of calf plate 5 with first feet plate joint swivel 2721, the extension tube of feet plate linear actuator 272 is affixed to the bottom of feet plate 6 with a second feet plate joint swivel 2721 and feet plate linkage 2722, such that the high/low of calf and feet plates can be controlled by the extend distance of calf plate linear actuator 271 and feet plate linear actuator 272.

In the present invention, when turn plates are turned to the right or left, openings between base plates and turn plates are created, this situation allows blanket to fall into the openings and cause turn plates not able to reposition properly, to solve this problem, as illustrated in FIG. 21, a plurality of blanket blocking rollers 28 are used to cover the openings, blanket blocking roller 28 comprises a roller spring 281 and a roller fabric 282, roller spring 281 is affixed to the edge of base plate, one end of roller fabric 282 is affixed to the side edge of turn plate, another end of roller fabric 282 is affixed to roller spring 281, such that when robotic care bed 1 is not in turn over mode, roller fabric 282 is rolled into roller spring 281, when turn plate is turn to the right or left, roller fabric 282 is pulled out of roller spring 281 by turn plate, creating a shield to cover the opening between base plate and turn plate to prevent blanket from falling into the opening.

Defecation and urination is always a big problem for patients, traditional method to solve this problem is to use bed pans or manual commode, this method requires lots of assistance from caregiver and is very unpleasant, in view of this, many automatic commode systems for care bed are invented, however, such automatic commode systems still have many shortcomings such as not easy for patients to position correctly to commode hole in bed, too big to fit under a wheelchair, not able to automatically put a lid on the feces bucket to prevent odor, not able to reposition commode seat properly, etc.

The present invention provides solutions to these problems, there are two types of patients, one type is fecal continence patient, another type is fecal incontinence patient, in view of this, the present invention provides two auto bidet systems, one is bidet system 7 for fecal continence patients, another one is incontinence bidet system 8 for fecal incontinence patients.

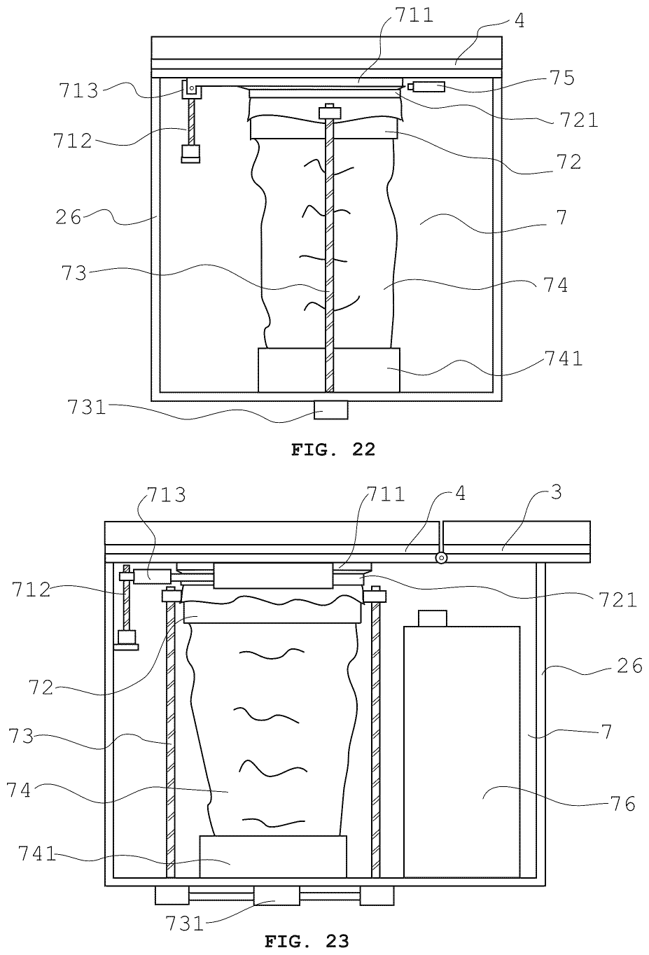

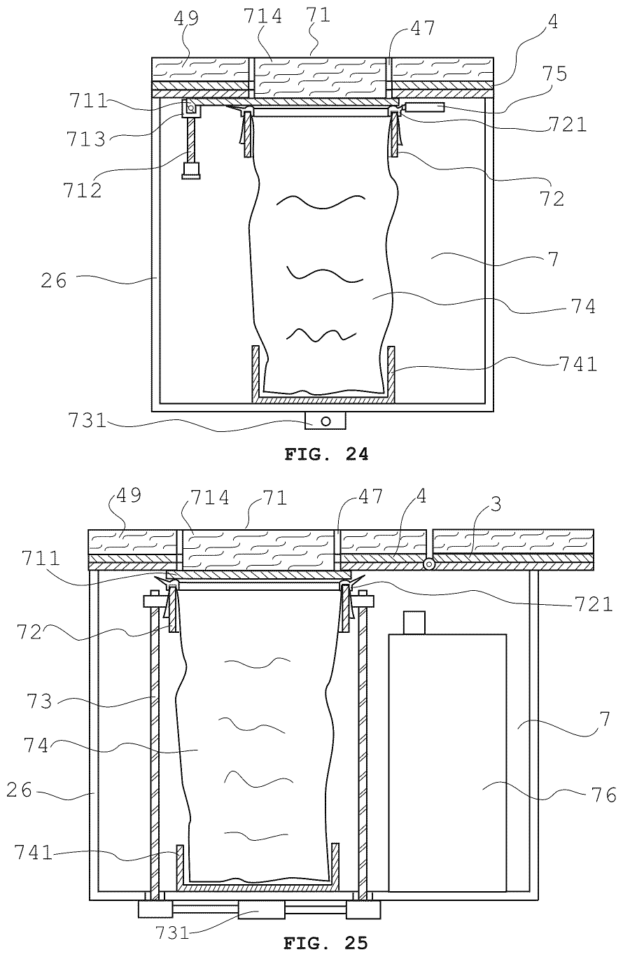

FIG. 22 illustrates the rear view of bidet system 7, FIG. 23 illustrates the side view of bidet system 7, FIG. 24 illustrates the cross section rear view of bidet system 7, FIG. 25 illustrates the cross section side view of bidet system 7, bidet system 7 comprises a bidet seat 71, a fecal bag holder 72, a fecal bag holder screw jack 73, a fecal bag 74, a cleaning device 75, and a water tank 76.

As illustrated in FIG. 22, FIG. 23, FIG. 24 and FIG. 25, bidet seat 71 further comprises a bidet seat plate 711, a bidet seat screw jack 712, a bidet seat turning device 713, and a bidet seat pad 714, bidet seat pad 714 has a thickness and is attached to the top of bidet seat plate 711, bidet seat pad 714 is positioned in bidet hole 47 when bidet system 7 is in ready to use mode, one end of bidet seat plate 711 is connected to bidet seat turning device 713, such that bidet seat 71 can be turned by bidet seat turning device 713, bidet seat turning device 713 is mounted on bidet seat screw jack 712 and can be moved up or down by bidet seat screw jack 712, fecal bag holder 72 is mounted on fecal bag holder screw jack 73, and is positioned right under bidet hole 47 and can be moved up or down by fecal bag holder screw jack 73, fecal bag holder screw jack 73 is driven by fecal bag holder screw jack motor 731, a fecal bag holder ring 721 is mounted on the top rim of fecal bag holder 72, it is made of soft elastic material such as silicon rubber and is capable of sealing odor from fecal bag 74 when fecal bag holder 72 is pushed against the bottom of bidet seat plate 711, fecal bag 74 is a flexible plastic bag and can be attached to or removed from fecal bag holder 72, fecal bag 74 is supported by fecal bag tray 742, cleaning device 75 has an extendable washing tube and an extendable drying tube that provide the needed washing and drying for patient's private part after defecation or urination, washing device 75 is connect to water tank 76 via water tube and get water supply from water tank 76.

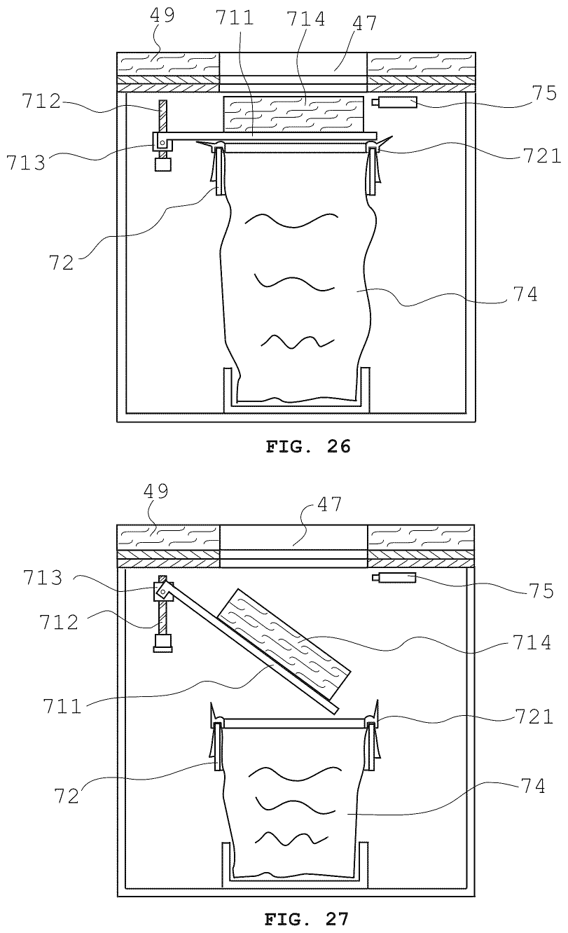

FIG. 26-FIG. 34 illustrated a complete operation cycle of bidet system 7.

As illustrated in FIG. 26, in order for patient to use bidet system 7, bidet seat pad 714 first must be moved away from bidet hole 47, since bidet seat pad 714 has a thickness, bidet seat screw jack 712 first lower bidet seat turning device 713, together with bidet seat 71, straight down to a position where the top of bidet seat pad 714 is just outside the bottom edge of bidet hole 47, at the same time fecal bag holder screw jack 73 also lower fecal bag holder 72 downward, such that bidet seat pad 714 is moved out of bidet hole 47.

As illustrated in FIG. 27, when bidet seat pad 714 is just moved out of bidet hole 47, bidet seat turning device 713 begin to turn bidet seat plate 711 downward, and bidet seat screw jack 712 move bidet seat turning device 713 up, at the same time fecal bag holder screw jack 73 continue to lower fecal bag holder 72 downward to make room for bidet seat 71 to be turned to the side.

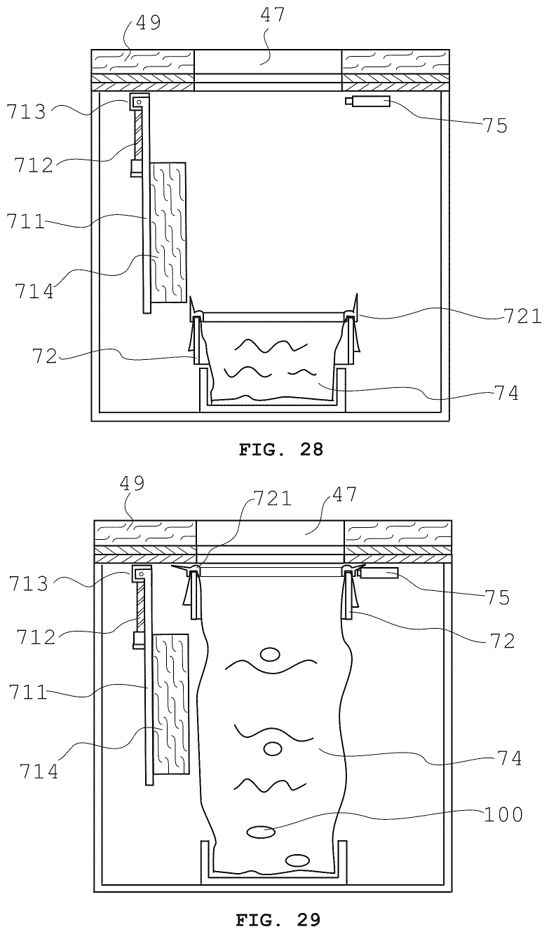

FIG. 28 illustrated the status in which fecal bag holder 72 is lowered to its lowest position, allows bidet seat 71 to be turned to the side.

As illustrated in FIG. 29, after bidet seat 71 is turned to the side and stay at the side, fecal bag holder screw jack 73 move fecal bag holder 72 upward to reach the bottom edge of bidet hole 47, making bidet system 7 ready for patient to urinate or defecate, urine and feces are collected in fecal bag 74.

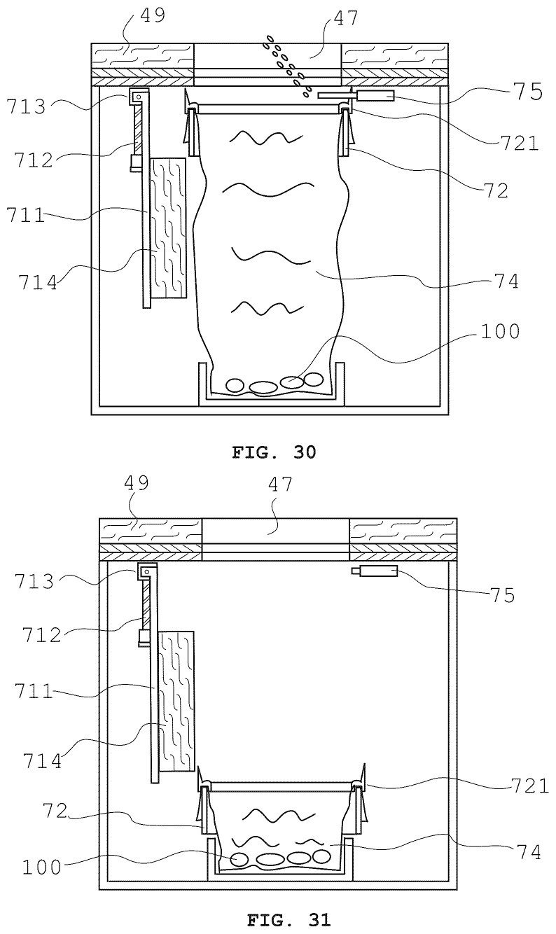

As illustrated in FIG. 30, after patient's urination or defecation is completed, bidet seat 71 stay at the side, the washing tube and drying tube of cleaning device 75 extend under fecal seat hole 47 to do the washing and drying.

As illustrated in FIG. 31, after cleaning and drying are completed, fecal bag holder 72 is moved downward by fecal bag holder screw jack 73 to its lowest position again, making room for bidet seat turning device 713 to turn bidet seat 71 upward to reposition.

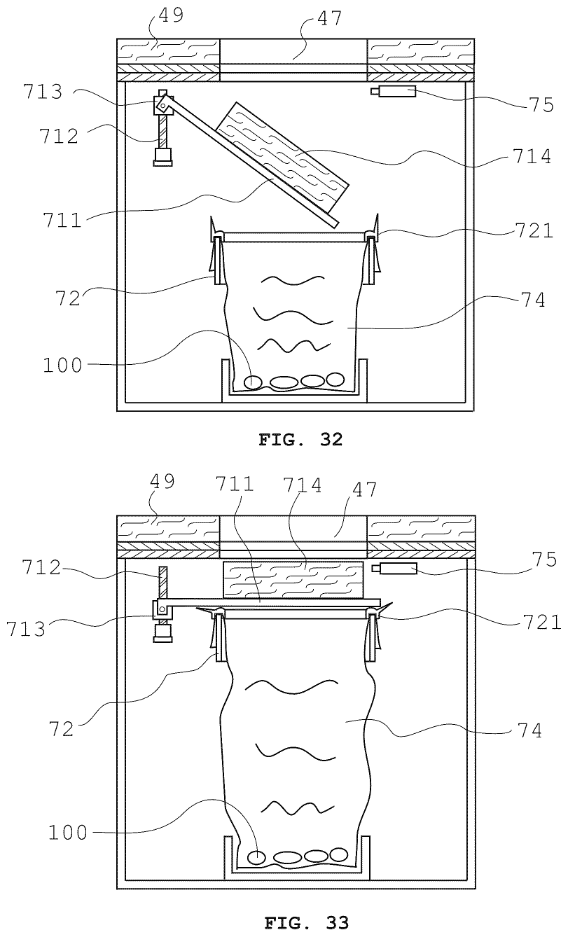

As illustrated in FIG. 32, as bidet seat 71 is turned upward to reposition, bidet seat screw jack 712 move bidet seat turning device 713 downward, and at the same time fecal bag holder screw jack 73 move fecal bag holder 72 upward.

As illustrated in FIG. 33, when the top edge of bidet seat pad 714 reach the bottom edge of bidet hole 47, the top rim of fecal bag holder 72 also reach the bottom of bidet seat plate 711.

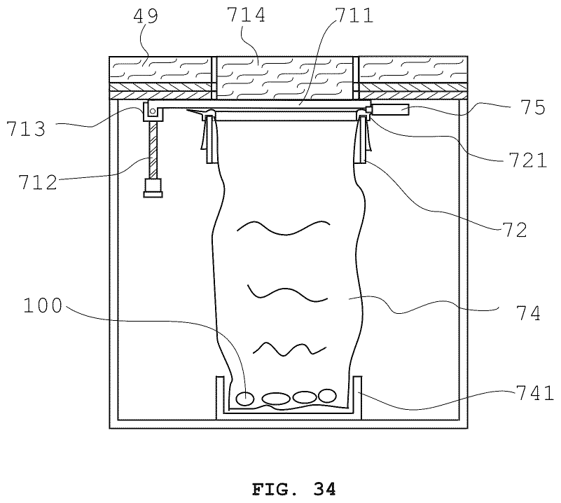

As illustrated in FIG. 34, bidet seat screw jack 712 move bidet seat turning device 713 and bidet seat 71 upward, and at the same time fecal bag holder screw jack 73 continue to move fecal bag holder 72 upward, the combined force of bidet seat screw jack 712 and fecal bag holder screw jack 73 push bidet seat pad 714 through bidet hole 47 and reposition, at this point bidet seat plate 711 serve as the lid for fecal bag 74, such that odor from fecal bag 74 is sealed by fecal bag holder ring 721 and bidet seat plate 711.

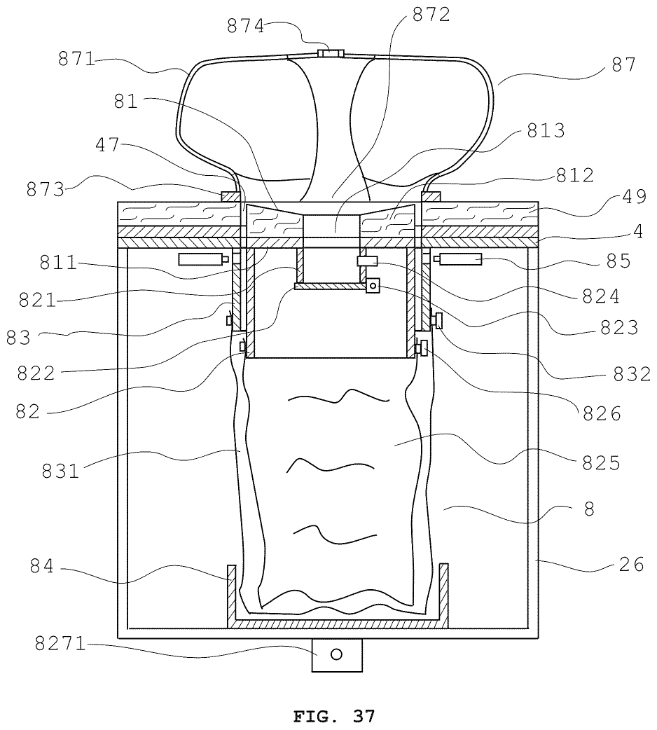

As illustrated in FIG. 35, FIG. 36 and FIG. 37, incontinence bidet system 8 comprises an incontinence bidet seat 81, an inner incontinence fecal bag holder 82, an inner incontinence fecal bag 825, an inner incontinence fecal bag holder screw jack 827, an outer incontinence fecal bag holder 83, an outer incontinence fecal bag 831, an incontinence fecal bag tray 84, an incontinence cleaning device 85, an incontinence water tank 86, and a butt retainer 87.

As illustrated in FIG. 35, FIG. 36 and FIG. 37, incontinence bidet seat 81 further comprises an incontinence bidet seat plate 811 and an incontinence bidet seat pad 812, incontinence bidet seat pad 812 has a thickness and is attached to the top of incontinence bidet seat plate 811, there is an incontinence fecal hole 813 locate in the middle portion of incontinence bidet seat 81, incontinence bidet seat pad 812 is positioned in bidet seat hole 47 when incontinence bidet system 8 is in ready to use mode, inner incontinence fecal bag holder 82 further comprises a fecal tube 821, the top of inner incontinence fecal bag holder 82 is affixed to the bottom of incontinence bidet seat plate 811, with the top of fecal tube 821 connected to the bottom of incontinence fecal hole 813, the bottom of fecal tube 821 is covered with a fecal tube cover 822, fecal tube cover 822 can be opened or closed by a fecal tube cover opening device 823, fecal tube cover opening device 823 is controlled by a fecal sensor 824, inner incontinence bidet fecal bag holder 82 is mounted on inner incontinence fecal bag holder screw jack 827, and can be moved up or down by inner incontinence fecal bag holder screw jack 827, inner incontinence fecal bag holder screw jack 827 is driven by an inner incontinence fecal bag holder screw jack motor 8271, inner incontinence fecal bag 825 is a flexible plastic bag and can be attached to or released from inner incontinence fecal bag holder 82 by an inner incontinence fecal bag fastener 826, odor from inner incontinence fecal bag 825 is sealed by incontinence bidet seat plate 811 and incontinence fecal tube cover 822.

As illustrated in FIG. 35, FIG. 36 and FIG. 37, an outer fecal bag holder 83 and an outer fecal bag 831 is used to collect excrement and cleaning water that fall through the gap between incontinence bidet seat 81 and thigh mattress pad 49, outer fecal bag holder 83 is larger than bidet hole 47, the top of outer incontinence fecal bag holder 83 is affixed to the bottom of thigh base pate 41, outer incontinence fecal bag 831 is a flexible plastic bag and can be attached to or removed from outer incontinence fecal bag holder 83 by an outer incontinence fecal bag fastener 832, both inner incontinence fecal bag 825 and outer incontinence fecal bag 831 are supported by an incontinence fecal bag tray 84, incontinence cleaning device 85 is capable of washing and drying the private part of a patient and incontinence bidet seat pad 812, incontinence cleaning device 85 is connected to incontinence water tank 86 via water tube and get water supply from water tank 86.

For fecal incontinence patients, they may urinate or defecate in any position in bed, to make sure they will urinate or defecate above bidet seat pad 812, it is necessary to retain patient's butt above incontinence bidet seat 812 and provide methods to clean incontinence bidet seat pad 812, as well as patient's private part from the above.

As illustrated in FIG. 35, FIG. 36 and FIG. 37, a briefs like butt retainer 87 is installed above bidet seat 81, butt retainer 87 is preferably made of water proof retainer fabric 871, butt retainer 87 has a bottom opening 872, the edge of bottom opening 872 can be attached to or removed from the edge of bidet hole 47 by retainer fastener 873, such that patient's butt can be retained above bidet seat 81 when they wear butt retainer 87, a retainer cleaning hole 874 is located on top of retainer 87 to allow caregiver to insert cleaning tube or dryer tube into butt retainer 87 to further clean and dry patient's butt and butt retainer 87 from the above, butt retainer 87 can be divided into several parts for easy wearing and cleaning.

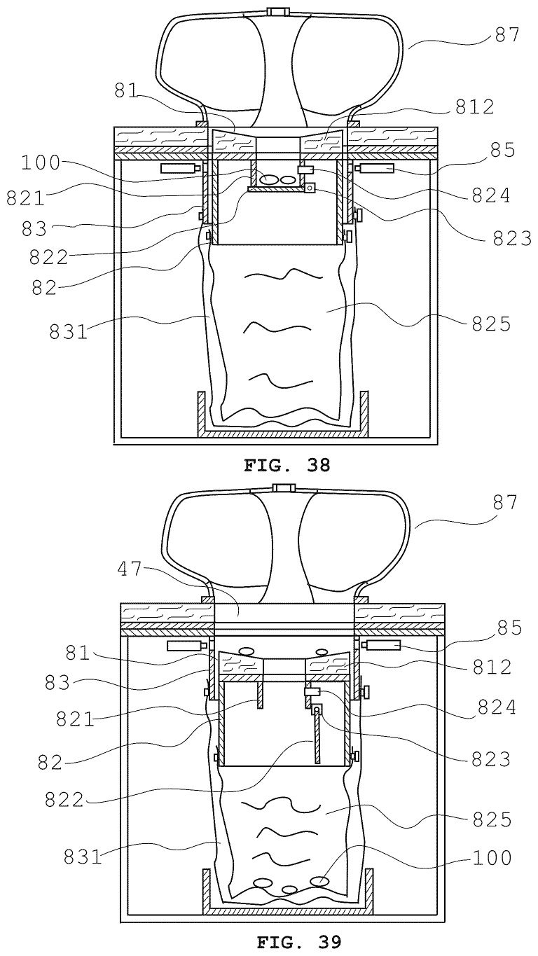

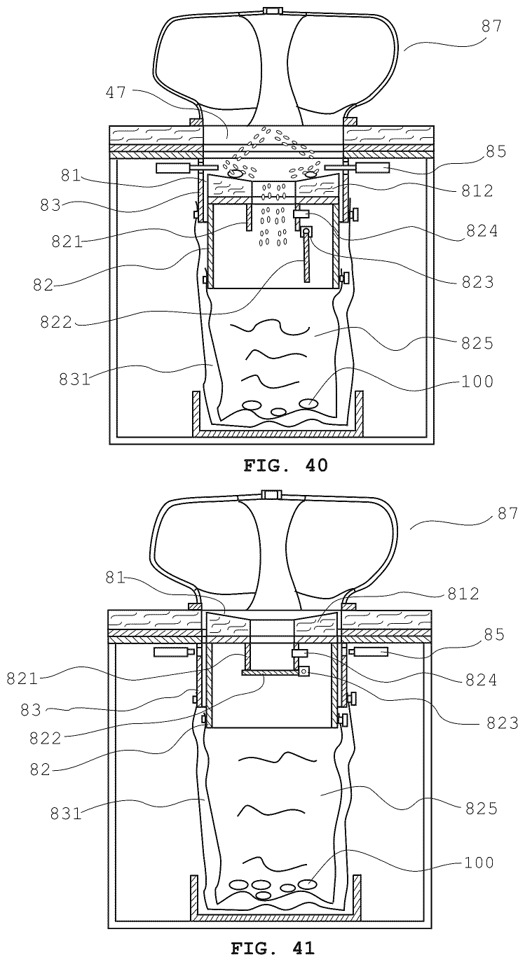

FIG. 38, FIG. 39, FIG. 40 and FIG. 41 illustrate a complete operation cycle of incontinence bidet system 8.

As illustrated in FIG. 38, when a fecal incontinence patient defecates or urinate, fecal sensor 824 detects the feces or urine and sends a signal to control system 12.

As illustrated in FIG. 39, control system 12 order inner incontinence fecal bag holder screw jack 827 to lower inner incontinence fecal bag holder 82, thus move incontinence bidet seat pad 812 out of bidet hole 47, at the same time control system 12 order fecal tube cover opening device 823 to open fecal tube cover 822 to allow feces or urine drop into inner fecal bag 825.

As illustrated in FIG. 40, after a preset time, the washing tube and drying tube of cleaning device 85 move in to wash and dry patient's private part and bidet seat pad 812, most washing water fall through fecal hole 813 and fecal tube 821 to inner incontinence fecal bag 825, washing water that fall through the gap between incontinence bidet seat 81 and outer fecal bag holder 83 fall into outer incontinence fecal bag 831.

As illustrated in FIG. 41, after patient's private part and bidet seat pad 812 are washed and dried, inner incontinence fecal bag holder 82 is moved up by inner incontinence fecal bag holder screw jack 827, making incontinence bidet seat 81 to reposition and ready for next defecation or urination.

### OTHER EMBODIMENTS

Other than rotate to the side, rotatable side 1121 and left rotatable side 1122 can be rotated upward or move to the side to make room for rotatable armrest 25 to setup and for wheelchair 21 to move out and to return to bed body opening easily.

For users who have difficulty control wheelchair 21, an navigation pilot system can be added to robotic care bed 1, such that patient can order electric wheelchair goes to a specific location or return to bed automatically.

Wheelchair 21 can be driven by electric if two of mobile body wheels 211 are replaced by two electric motor wheels 212.

Right stationary side 1112 and left stationary side 1113 can be made to tilt toward the middle of robotic care bed 1 while it is turning over, such that patient can be prevented from sliding to the sides while turning over.

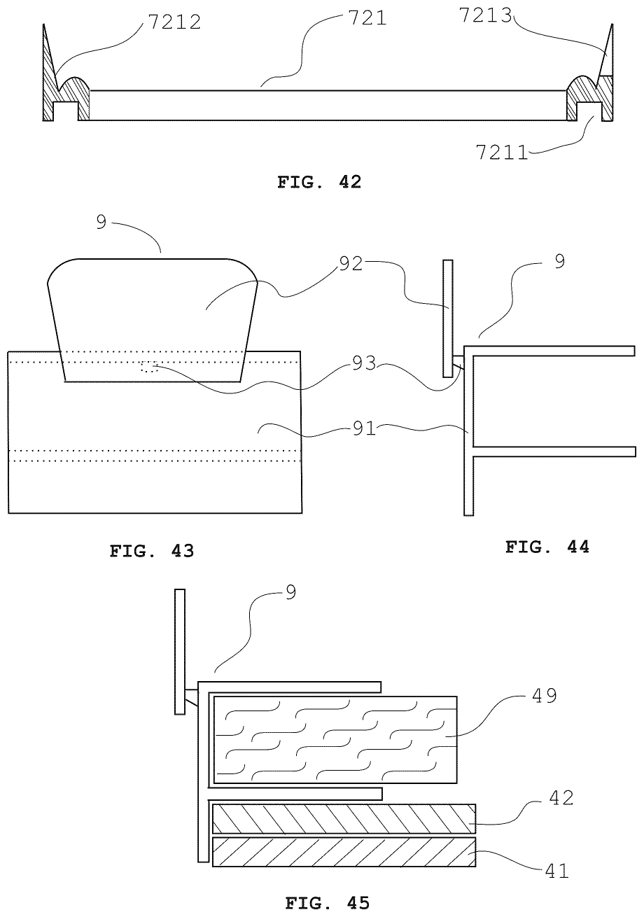

As illustrated in FIG. 42, fecal bag holder ring 721 can be used to attach fecal bag 74 to fecal bag holder 72, to seal odor from fecal bag 74, and to prevent water from spilling into mobile body chamber 26 while cleaning, fecal bag holder ring 721 is made of soft elastic material such as silicon rubber, it has a mounting groove 7211, a water guarding wall 7212, and a cleaning tube opening 7213, mounting groove 7211 is located at the bottom and is made to the same size and shape of the top rim of fecal bag holder, and can be snapped into or removed from the top rim of fecal bag holder 72 with fecal bag 74 installed to fecal bag holder 72 inside out, water guarding wall is around the outer edge of fecal bag holder ring 721, it has a height and a cross section shape of triangle, and has a cleaning tube opening 7213 that allows the cleaning tube of cleaning device 75 to extend under bidet hole 47 for cleaning, water guarding wall 7212 stay in upright position when no force is applied to it, and it can be bended flat outward when force is applied to it, such that when fecal bag holder 72 is moved up by fecal bag holder screw jack 73 to make fecal bag holder ring 721 against the rear of bidet seat plate 711, water guarding wall is bended flat outward, bidet seat plate 711 serves as a lid for fecal bag 74, such that odor can be sealed by fecal bag holder ring 721 and bidet seat plate 711, when fecal bag holder move down a distance of the height of water guarding wall 7212, water guarding wall 7212 return to upright position, such that when the cleaning tube of cleaning device 75 extend under fecal hole 47 to do the cleaning, spilling water will be blocked by water guarding wall 7212.

For bidet system 7, because there are gaps along the edge of bidet hole 47, to prevent urine spill into these gaps or over thigh plate mattress pad 49, it is necessary to block these urine spill with a urine guard.

FIG. 43 illustrates the front view of urine guard 9, FIG. 44 illustrates the side view of urine guard 9, FIG. 45 illustrates the cross section side view of an installed urine guard 9, urine guard 9 is made of elastic material such as silicon rubber, it has a bottom urine blocking plate 91 and a top urine blocking plate 92, bottom urine blocking plate 91 can be attached or removed from thigh mattress pad 49, top urine blocking plate 92 is connected to the top of bottom urine blocking plate 91 with a stem 93, the bottom edge of top urine blocking plate 92 overlap the top edge of bottom urine blocking plate 91, top urine blocking plate 92 remain in upright position when no weight is put on it, and it will be bended down when a patient's body weight is put on it, when patient use the bidet system 7, the body weight move away, and top urine blocking plate 92 resume to upright position to block spilling urine.

Having thus disclosed a number of preferred embodiments of the present invention, it being understood that numerous modifications and additions are contemplated and will now be apparent to those having benefit of the above disclosure, what is claimed is:

1. A robotic care bed comprising a bed body, a mobile body, and a control system, said mobile body can be converted into a wheelchair automatically, said bed body and said mobile body can be automatically locked together or unlocked from each other by electromagnet means;
a) said bed body comprising a stationary part, a right rotatable side, a left rotatable side, an auto charging device, and a return guiding system, said stationary part further comprising a stationary head, a right stationary side, and a left stationary side, said stationary part, said right rotatable side and said left rotatable side form a bed body opening in the middle portion of said bed body to accommodate said mobile body, said auto charging device is capable of automatically charging said mobile body when said mobile body is parked in said bed body opening, said return guiding system is capable of guiding said wheelchair return to said bed body opening easily;
wherein a first wheeled leg is affixed to one end of said right rotatable side, the other end of said right rotatable side is jointed to said right stationary side with a first sideward hinge, said right rotatable side can be rotated to the right side by a first sideward rotating device, a second wheeled leg is affixed to one end of said left rotatable side, the other end of said left rotatable side is jointed to said left stationary side with a second sideward hinge, said left rotatable side can be rotated to the left side by a second sideward rotating device;
such that when said right rotatable side and said left rotatable side are rotated to the side, said bed body opening is enlarged, and a space is created for said mobile body to be converted into said wheelchair automatically, and for said wheelchair to move out or return to said bed body opening easily;
wherein at least one back plate electromagnet is affixed to the inner edge of said stationary head, at least one calf plate electromagnet is affixed to the inner edge of said right or left rotatable side, at least one feet plate electromagnet is affixed to the inner edge of said right or left rotatable side;
b) said mobile body comprising a double plate high/low and turn over structure, a calf plate, a feet plate, a calf and feet plate high/low device, a mobile body chamber, an auto armrest system, a bidet system, at least three mobile body wheels, a rechargeable battery, and a plurality of blanket blocking rollers;
wherein said double plate high/low and turn over structure comprising a back plate, a thigh plate, a back plate high/low and turn over device, and a thigh plate high/low and turn over device;
wherein said back plate comprising a back base plate and a back turn plate;
wherein a right back base plate electromagnet is affixed to the right side of said back base plate, a left back base plate electromagnet is affixed to the left side of said back base plate, at least one back base plate window is opened in said back base plate;
wherein said back turn plate comprising a right back turn plate, a left back turn plate, and at least one center back turn plate, said right back turn plate, said left back turn plate, and said center back turn plate are jointed together by a plurality of back turn plate hinges, a right back turn plate magnet locking piece is affixed to the bottom of said right back turn plate, in a location corresponding to said right back base plate electromagnet, a left back turn plate magnet locking piece is affixed to the bottom of said left back turn plate, in a location corresponding to said left back base plate electromagnet;
wherein said back plate is formed by placing said back turn plate on top of said back base plate, with said right back turn plate magnet locking piece locates above said right back base plate electromagnet, and said left back turn plate magnet locking piece locates above said left back base plate electromagnet;
wherein the locking and unlocking of said right back base plate electromagnet with said right back turn plate magnet locking piece, and the locking and unlocking of said left back base plate electromagnet with said left back turn plate magnet locking piece are controlled by electricity;
such that when said right back base plate electromagnet is locked with said right back turn plate magnet locking piece and said left back base plate electromagnet is locked with said left back turn plate magnet locking piece, said back turn plate is combined with said back base plate into one piece;
such that when said right back base plate electromagnet is locked with said right back turn plate magnet locking piece and said left back base plate electromagnet is unlocked with said left back turn plate magnet locking piece, said left back turn plate and said center back turn plate can be rotated to the right;
such that when said right back base plate electromagnet is unlocked with said right back turn plate magnet locking piece and said left back base plate electromagnet is locked with said left back turn plate magnet locking piece, said right back turn plate and said center back turn plate can be rotated to the left;
wherein said thigh plate comprising a thigh base plate and a thigh turn plate, a bidet hole is opened in said thigh plate;
wherein a right thigh base plate electromagnet is affixed to the right side of said thigh base plate, a left thigh base plate electromagnet is affixed to the left side of said thigh base plate, at least one thigh base plate window is opened in said thigh base plate;
wherein said thigh turn plate comprising a right thigh turn plate, a left thigh turn plate, and at least one center thigh turn plate, said right thigh turn plate, said left thigh turn plate, and said center thigh turn plate are jointed together by a plurality of thigh turn plate hinges, a right thigh turn plate magnet locking piece is affixed to the bottom of said right thigh turn plate, in a location corresponding to said right thigh base plate electromagnet, a left thigh turn plate magnet locking piece is affixed to the bottom of said left thigh turn plate, in a location corresponding to said left thigh base plate electromagnet;
wherein said thigh plate is formed by placing said thigh turn plate on top of said thigh base plate, with said right thigh turn plate magnet locking piece locates above said right thigh base plate electromagnet, and said left thigh turn plate magnet locking piece locates above said left thigh base plate electromagnet;
wherein the locking and unlocking of said right thigh base plate electromagnet with said right thigh turn plate magnet locking piece, and the locking and unlocking of said left thigh base plate electromagnet with said left thigh turn plate magnet locking piece are controlled by electricity;
such that when said right thigh base plate electromagnet is locked with said right thigh turn plate magnet locking piece and said left thigh base plate electromagnet is locked with said left thigh turn plate magnet locking piece, said thigh turn plate is combined with said thigh base plate into one piece;
such that when said right thigh base plate electromagnet is locked with said right thigh turn plate magnet locking piece and said left thigh base plate electromagnet is unlocked with said left thigh turn plate magnet locking piece, said left thigh turn plate and said center back turn plate can be rotated to the right;
such that when said right thigh base plate electromagnet is unlocked with said right thigh turn plate magnet locking piece and said left thigh base plate electromagnet is locked with said left thigh turn plate magnet locking piece, said right thigh turn plate and said center thigh turn plate can be rotated to the left;
wherein the bottom edge of said back base plate is jointed to the top edge of said thigh base plate with a first plate hinge, the bottom edge of said thigh base plate is jointed to the top edge of said calf plate with a second plate hinge, the bottom edge of said calf plate is jointed to the top edge of said feet plate with a third plate hinge;
wherein said back plate high/low and turn over device comprising a right back plate linear actuator, a left back plate linear actuator, a plurality of bottom back plate multi direction swivels, and a plurality of top back plate multi direction swivels;
wherein the bottom of said right back plate linear actuator is jointed to a first bottom back plate multi direction swivel, the extension tube of said right back plate linear actuator is extended through said back base plate window and is jointed to a first top back plate multi direction swivel, said first top back plate multi direction swivel is affixed to the right bottom of said center turn plate, the bottom of said left back plate linear actuator is jointed to a second bottom back plate multi direction swivel, the extension tube of said left back plate linear actuator is extended through said back base plate window and is jointed to a second top back plate multi direction swivel, said second top back plate multi direction swivel is affixed to the left bottom of said center turn plate;
such that the high/low and turn over functions of said back plate can be operated by said back plate high/low and turn over device;
wherein said thigh plate high/low and turn over device comprising a least one right thigh plate linear actuator, at least one left thigh plate linear actuator, a plurality of bottom thigh plate multi direction swivels, and a plurality of top thigh plate multi direction swivels;
wherein the bottom of said right thigh plate linear actuator is jointed to a first bottom thigh plate multi direction swivel, the extension tube of said right thigh plate linear actuator is extended through said thigh base plate window and is jointed to a first top thigh plate multi direction swivel, said first top thigh plate multi direction swivel is affixed to the right bottom of said center thigh turn plate, the bottom of said left thigh plate linear actuator is jointed to a second bottom thigh plate multi direction swivel, the extension tube of said left thigh plate linear actuator is extended through said thigh base plate window and is jointed to a second top thigh plate multi direction swivel, said second top thigh plate multi direction swivel is affixed to the left bottom of said center thigh turn plate;
such that the high/low and turn over functions of said thigh plate can be operated by said thigh plate high/low and turn over device;
wherein said calf and feet plate high/low device comprising at least one calf and feet plate linear actuator, at least one calf and feet plate linkage, and a plurality of calf and feet plate swivels;
wherein said calf and feet plate high/low device is connected to said calf plate and said feet plate;
such that the high/low function of said calf plate and said feet plate can be operated by said calf and feet plate high/low device;
wherein said thigh base plate is mounted on top said mobile body chamber, said back plate high/low and turn over device, said thigh plate high/low and turn over device, and said bidet system are housed in said mobile body chamber, said mobile body chamber is mounted on said mobile body wheels, said rechargeable battery is mounted in said mobile body chamber and can be automatically charged by said auto charging device, said rechargeable battery is capable of providing electric power to all electric parts in said mobile body;
such that said mobile body can be converted into a wheelchair or laid flat by said back plate high/low and turn over device and said calf and feet plate high/low device;
wherein at least one back plate magnet locking piece is affixed to the outer edge of said back plate, in location corresponding to said back plate electromagnet when said mobile body is laid flat in said bed body opening, at least one calf plate magnet locking piece is affixed to the outer edge of said calf plate, in location corresponding to said calf plate electromagnet when said mobile body is laid flat in said bed body opening, at least one feet plate magnet locking piece is affixed to the outer edge of said feet plate, in location corresponding to said feet plate electromagnet when said mobile part is laid flat in said bed body opening;
such that when said mobile body is parked in said bed body opening and is laid flat, said back plate can be locked or unlocked by said back plate electromagnet, said calf plate can be locked or unlocked by said calf plate electromagnet, and said feet plate can be locked or unlocked by said feet plate electromagnet, such that said mobile body can be locked or unlocked with said bed body;
wherein said bidet system is capable of automatically collecting excrement from an user with at least one flexible fecal bag, cleaning the private part of said user, and sealing odor from said fecal bag;
wherein said blanket blocking roller is capable of covering the opening between said base plate and said turn plate when said mobile body turn over to the right or left, such that blanket can be prevented from falling into said opening;
c) said control system is connected to said robotic care bed electronically and is capable of accepting orders from a person and instruct said robotic care bed to perform the necessary functions.

2. The high/low and turn over structure in claim 1 comprising a back plate, a back plate high/low and turn over device, a thigh plate, and a thigh plate high/low and turn over device;
a) said back plate comprising a back base plate and a back turn plate;
wherein a right back base plate electromagnet is affixed to the right side of said back base plate, a left back base plate electromagnet is affixed to the left side of said back base plate, at least one back base plate window is opened in said back base plate;
wherein said back turn plate comprising a right back turn plate, a left back turn plate, a right center back turn plate, and a left center back turn plate, said right back turn plate, said left back turn plate, said right center back turn plate, and said left center back turn plate are jointed together by a plurality of back turn plate hinges, a right back turn plate magnet locking piece is affixed to the bottom of said right back turn plate, in a location corresponding to said right back base plate electromagnet, a left back turn plate magnet locking piece is affixed to the bottom of said left back turn plate, in a location corresponding to said left back base plate electromagnet;
wherein said back plate is formed by placing said back turn plate on top of said back base plate, with said right back turn plate magnet locking piece locates above said right back base plate electromagnet, and said left back turn plate magnet locking piece locates above said left back base plate electromagnet;
wherein the locking and unlocking of said right back base plate electromagnet with said right back turn plate magnet locking piece, and the locking and unlocking of said left back base plate electromagnet with said left back turn plate magnet locking piece are controlled by electricity;
such that when said right back base plate electromagnet is locked with said right back turn plate magnet locking piece and said left back base plate electromagnet is locked with said left back turn plate magnet locking piece, said back turn plate is combined with said back base plate into one piece;
such that when said right back base plate electromagnet is locked with said right back turn plate magnet locking piece and said left back base plate electromagnet is unlocked with said left back turn plate magnet locking piece, said left back turn plate, said left center back turn plate and said right center back turn plate can be rotated to the right;
such that when said right back base plate electromagnet is unlocked with said right back turn plate magnet locking piece and said left back base plate electromagnet is locked with said left back turn plate magnet locking piece, said right back turn plate, said right center back turn plate and said left center back turn plate can be rotated to the left;
b) said back plate high/low and turn over device comprising a right back plate linear actuator, a left back plate linear actuator, a plurality of bottom back plate multi direction swivels, and a plurality of top back plate multi direction swivels;
wherein the bottom of said right back plate linear actuator is jointed to a first bottom back plate multi direction swivel, the extension tube of said right back plate linear actuator is extended through said back base plate window and is jointed to a first top back plate multi direction swivel, said first top back plate multi direction swivel is affixed to the bottom of said right center turn plate, the bottom of said left back plate linear actuator is jointed to a second bottom back plate multi direction swivel, the extension tube of said left back plate linear actuator is extended through said back base plate window and is jointed to a second top back plate multi direction swivel, said second top back plate multi direction swivel is affixed to the bottom of said left center turn plate;
c) said thigh plate comprising a thigh base plate and a thigh turn plate;
wherein a right thigh base plate electromagnet is affixed to the right side of said thigh base plate, a left thigh base plate electromagnet is affixed to the left side of said thigh base plate, there is at least one thigh base plate window is opened in said thigh base plate;
wherein said thigh turn plate comprising a right thigh turn plate, a left thigh turn plate, a right center thigh turn plate, and a left center thigh turn plate, said right thigh turn plate, said left thigh turn plate, said right center thigh turn plate, and said left center thigh turn plate are jointed together by a plurality of thigh turn plate hinges, a right thigh turn plate magnet locking piece is affixed to the bottom of said right thigh turn plate, in a location corresponding to said right thigh base plate electromagnet, a left thigh turn plate magnet locking piece is affixed to the bottom of said left thigh turn plate, in a location corresponding to said left thigh base plate electromagnet;
wherein said thigh plate is formed by placing said thigh turn plate on top of said thigh base plate, with said right thigh turn plate magnet locking piece locate above said right thigh base plate electromagnet, and said left thigh turn plate magnet locking piece locate above said left thigh base plate electromagnet;
wherein the locking and unlocking of said right thigh base plate electromagnet with said right thigh turn plate magnet locking piece, and the locking and unlocking of said left thigh base plate electromagnet with said left thigh turn plate magnet locking piece are controlled by electricity;
such that when said right thigh base plate electromagnet is locked with said right thigh turn plate magnet locking piece and said left thigh base plate electromagnet is locked with said left thigh turn plate magnet locking piece, said thigh turn plate is combined with said thigh base plate into one piece;
such that when said right thigh base plate electromagnet is locked with said right thigh turn plate magnet locking piece and said left thigh base plate electromagnet is unlocked with said left thigh turn plate magnet locking piece, said left thigh turn plate, said left center thigh turn plate and said right center thigh turn plate can be rotated to the right;
such that when said right thigh base plate electromagnet is unlocked with said right thigh turn plate magnet locking piece and said left thigh base plate electromagnet is locked with said left thigh turn plate magnet locking piece, said right thigh turn plate, said right center thing turn plate and said left center thigh turn plate can be rotated to the left;
d) said thigh plate high/low and turn over device comprising a least one right thigh plate linear actuator, at least one left thigh plate linear actuator, a plurality of bottom thigh plate multi direction swivels, and a plurality of top thigh plate multi direction swivels;
wherein the bottom of said right thigh plate linear actuator is jointed to a first bottom thigh plate multi direction swivel, the extension tube of said right thigh plate linear actuator is extended through said thigh base plate window and is jointed to a first top thigh plate multi direction swivel, said first top thigh plate multi direction swivel is affixed to the bottom of said right center thigh turn plate, the bottom of said left thigh plate linear actuator is jointed to a second bottom thigh plate multi direction swivel, the extension tube of said left thigh plate linear actuator is extended through said thigh base plate window and is jointed to a second top thigh plate multi direction swivel, said second top thigh plate multi direction swivel is affixed to the bottom of said left center thigh turn plate;
wherein said thigh base plate is mounted on a platform, the top edge of said thigh base plate is jointed to the bottom edge of said back base plat with at least one plate hinge;
such that said back plate can be rotated around said plate hinge to form an angle with said thigh base plate;
such that when said double plate high/low and turn over structure receives an order to raise said back plate, said back turn plate is locked with said back base plate into one piece, said right back plate linear actuator and said left back plate linear actuator extend at the same speed to the same distance, such that said back plate is rotated upward around said plate hinge to form a desired angle with said thigh plate;
such that when said double plate high/low and turn over structure receives an order to turn over to the right, said left back turn plate is unlocked from said back base plate, said left thigh turn plate is unlocked from said thigh base plate, when said left back plate linear actuator and said left thigh plate linear actuator extend a long distance, said right back plate linear actuator and said right thigh plate linear actuator extend a short distance, said back turn plate and said thigh turn plate are rotated to the right to a desired angle and curve;
such that when said double plate high/low and turn over structure receives an order to turn over to the left, said right back turn plate is unlocked from said back base plate, said right thigh turn plate is unlocked from said thigh base plate, when said right back plate linear actuator and said right thigh plate linear actuator extend a long distance, said left back plate linear actuator and said left thigh plate linear actuator extend a short distance, said back turn plate and said thigh turn plate are rotated to the left to a desired angle and curve;
wherein said thigh plate high/low and turn over device comprising a front right thigh plate linear actuator, a rear right thigh plate linear actuator, a front left thigh plate linear actuator, a rear left thigh plate linear actuator, a plurality of bottom thigh plate multi direction swivels, and a plurality of top thigh plate multi direction swivels;
such that said thigh turn plate can be tilted to different directions, or go straight up by adjusting the extended distance of said front right thigh plate linear actuator, said rear right thigh plate linear actuator, said front left thigh plate linear actuator, and said rear left thigh plate linear actuator.

3. The auto armrest system in claim 1 comprising two rotatable armrests, each said rotatable armrest comprising a rotatable arm, an armrest bar, an armrest rotating device, an armrest locking piece, and an armrest lock;
wherein said armrest rotating device is installed on each side of said mobile body chamber, one end of said rotatable arm is connected to said armrest rotating device, another end of said rotatable arm is connected to said armrest bar perpendicularly, said armrest locking piece is affixed to the long end of said armrest bar, said armrest lock is affixed to the edge of said back plate, in a location corresponding to said armrest locking piece when said wheelchair is setup, said armrest lock can be electromagnet or mechanical;
wherein said rotatable armrests are installed in such way that when said mobile body is parked in said bed body opening and is laid flat, said rotatable arms are further away from said stationary head than said sideward hinges, such that when said right rotatable side and said left rotatable are rotated to the side, said armrest bars have room to be rotated upward for setting up;
wherein said rotatable armrest are installed in such way that when said mobile body is parked in said bed body opening and is laid flat, said armrest bars are held under said thigh plate by said rotatable arms;
such that when said control system receive an order to covert said mobile body into a wheelchair, said right rotatable side and said left rotatable side are rotated to the side by said side rotating devices, and said armrest rotating devices rotate said rotatable arms upward until said armrest bars parallel to said thigh plate, and making said armrest locking pieces move to the locations of said armrest locks, such that the long end of said armrest bars are locked with said back plate by said armrest locks, such that said armrests are automatically locked to said wheelchair.

4. The return guiding system in claim 1 comprising a return guiding rail and two return guiding light beam generators, said return guiding rail is installed along said bed body opening and has a wide open entrance, each side of said entrance is installed with a return guiding light beam generator, said return guiding light beam generator can generates visible light beam to indicate the location of said entrance to a wheelchair user, such that said wheelchair user can follow said light beams to return to said bed body opening easily.

5. The calf and feet plate high/low device in claim 1 comprising a calf plate linear actuator, two calf plate joint swivels, a feet plate linear actuator, two feet plate joint swivels, and a feet plate linkage, the base of said calf plate linear actuator is affixed to the front of said mobile body chamber via a first calf plate joint swivel, the extension tube of said calf plate linear actuator is affixed to the bottom of said calf plate via a second calf plate joint swivel, the base of said feet plate linear actuator is affixed to the bottom of said calf plate via a first feet plate joint swivel, the extension tube of said feet plate linear actuator is affixed to the bottom of said feet plate via a second feet plate joint swivel and said feet plate linkage, such that the high/low of said calf and feet plates can be controlled by the extended distance of said calf plate linear actuator and said feet plate linear actuator.

6. The blanket blocking roller in claim 1, comprising a roller spring and a roller fabric, said roller spring is affixed to the edge of said back base plate or said thigh base plate, one end of said roller fabric is affixed to the edge of said back turn plate or said thigh turn plate, another end of said roller fabric is affixed to said roller spring;
such that when said double plate high/low and turn over system is not in turn over mode, said roller fabric is rolled into said roller spring, when said turn plate is turn to the right or left, said roller fabric is pulled out from said roller spring by said turn plate, creating a shield to cover the opening between said base plate and said turn plate, thus preventing a blanket from falling into said opening.

7. A bidet system for use in a care equipment, said care equipment has a chamber to accommodate said bidet system, said chamber has a top panel, a bidet hole is opened in said top panel, said bidet system comprising a bidet seat, a fecal bag holder, a fecal bag holder ring, a fecal bag holder moving device, a fecal bag, a cleaning device, a water tank, and a urine guard;
a) said bidet seat comprising a bidet seat plate, a bidet seat moving device, a bidet seat turning device, and a bidet seat pad, said bidet seat pad has a thickness and is attached to the top of said bidet seat plate, said bidet seat pad is positioned in said bidet hole when said bidet system is not in use, one end of said bidet seat plate is connected to said bidet seat turning device, said bidet seat turning device is mounted on said bidet seat moving device;
such that said bidet seat can be moved up or down by said bidet seat moving device, and can be turned by said bidet seat turning device;
b) said fecal bag holder is mounted on said fecal bag holder moving device and is positioned right under said bidet hole and can be moved up or down by said fecal bag holder moving device;
c) said fecal bag holder ring is made of elastic material and can be mounted on the top rim of said fecal bag holder;
d) said fecal bag is a flexible plastic bag and can be attached to or removed from said fecal bag holder, and is capable of holding liquid waste;
such that when said fecal bag holder is moved up by said fecal bag holder moving device to against the bottom of said bidet seat plate, said bidet seat plate serves as a lid for said fecal bag, odor from said fecal bag can be sealed by said bidet seat plate and said fecal bag holder ring;
e) said cleaning device has a washing unit and a drying unit and is capable of cleaning and drying the private part of an user, said cleaning device is connected to said water tank via a water tube and get water supply from said water tank;
f) said urine guard is capable of preventing urine from spilling into the edge of said bidet hole and over said thigh plate;
such that when said bidet system receive an user's order of defecation or urination, said bidet seat turning device, together with said bidet seat are lowered by said bidet seat moving device, at the same time said fecal bag holder is lowered by said fecal bag holder moving device, such that said bidet seat is moved out of said bidet hole;
such that when said bidet seat is just moved out of said bidet hole, said bidet seat turning device begin to rotate said bidet seat plate downward, and said bidet seat moving device move said bidet seat turning device upward, at the same time said fecal bag holder moving device continue to move said fecal bag holder downward to make room for said bidet seat to be rotated to the side, after said bidet seat is rotated to the side, said fecal bag holder moving device move said fecal bag holder upward to reach the bottom edge of said bidet hole, ready for said user to urinate or defecate, urine and feces are collected in said fecal bag;
such that after said user's urination or defecation is completed, said bidet seat stay at the side, said washing unit and said drying unit move in to do the cleaning and drying, waste water is collected in said fecal bag, after cleaning is completed, said fecal bag holder is moved downward by said fecal bag holder moving device to make room for said bidet seat to be rotated upward to reposition;
such that when said bidet seat plate is rotated upward by said bidet seat turning device to reposition, said bidet seat turning device is moved downward by said bidet seat moving device, at the same time said fecal bag holder is moved upward by said fecal bag holder moving device;
such that when said bidet seat pad is rotated to a level position and just outside said bidet hole, the rotation of said bidet seat stop, the top rim of said fecal bag holder reach the bottom of said bidet seat plate, said bidet seat turning device and said bidet seat plate are continue to be moved upward by said bidet seat moving device, and at the same time said fecal bag holder continue to be moved upward by said fecal bag holder moving device, such that said bidet seat is pushed through said bidet hole and reposition by the force of said bidet seat moving device and said fecal bag holder moving device, such that said fecal bag holder ring is pushed against the bottom of said bidet seat plate to provide seal for said fecal bag to prevent odor.

8. The fecal bag holder ring in claim 7 is made of soft elastic material such as silicon rubber, it has a mounting groove, a water guarding wall, and a cleaning tube opening, said mounting groove is located at the bottom of said fecal bag holder ring and is made to the same size and shape of the top rim of said fecal bag holder, and can be snapped into or removed from the top rim of said fecal bag holder, said water guarding wall is around the outer edge of said fecal bag holder ring, said water guarding wall stay in upright position when no force is applied to it and can be bended outward when force is applied to it, said cleaning tube opening is opened in said water guarding wall to allow said washing unit and drying unit of said cleaning device to extend under said bidet hole for cleaning;
such that said fecal bag can be attached or removed from the top rim of said fecal bag holder by said fecal bag holder ring;
such that when said fecal bag holder is moved up to against the bottom of said bidet seat plate, said water guarding wall is bended outward, said bidet seat plate serves as a lid for said fecal bag, said fecal bag holder ring serves as an odor sealing ring;
such that when said fecal bag holder move down a distance of the height of said water guarding wall, no force is applied to said water guarding wall, said water guarding wall return to upright position to prevent water from spilling into said mobile body chamber while cleaning.

9. The urine guard in claim 7 is made of elastic material such as silicon rubber, it has a bottom urine blocking plate and a top urine blocking plate, said bottom urine blocking plate can be attached or removed from the edge of said bidet hole, said top urine blocking plate is connected to the top edge of said bottom urine blocking plate with a stem;
such that said top urine blocking plate remain in upright position when no weight is put on it, and it can be bended down when a weight is put on it;
such that when an user use said bidet system, the body weight of said user move away from said urine guard, said top urine blocking plate return to upright position to prevent urine from spilling over the top of said bidet hole, and said bottom urine blocking plate can prevent urine from spilling into the edge of said bidet hole.

10. An incontinence bidet system for use in a care equipment, said care equipment has a chamber to accommodate said incontinence bidet system, said chamber has a top panel, a bidet hole is opened in said top panel, said incontinence bidet system comprising an incontinence bidet seat, an inner incontinence fecal bag holder, an inner incontinence fecal bag holder moving device, an inner incontinence fecal bag, an outer incontinence fecal bag holder, an outer incontinence fecal bag, an incontinence cleaning device, an incontinence water tank, and a butt retainer;
a) said incontinence bidet seat comprising an incontinence bidet seat plate and an incontinence bidet seat pad, said incontinence bidet seat pad has a thickness and is attached to the top of said incontinence bidet seat plate, an incontinence fecal hole is opened in the middle portion of said incontinence bidet seat, said incontinence bidet seat pad is positioned in said bidet hole when said incontinence bidet system is not in use;
b) said inner incontinence fecal bag holder is a little smaller or the same size of said incontinence bidet seat plate, said inner incontinence fecal bag holder comprising a fecal tube, the top of said inner incontinence fecal bag holder is affixed to the rear of said incontinence bidet seat plate, with the top of said fecal tube connected to the bottom of said incontinence fecal hole, the bottom of said fecal tube is covered with a fecal tube cover, said fecal tube cover can be opened or closed by a fecal tube cover opening device, said fecal tube cover opening device is controlled by a fecal sensor, said inner incontinence fecal bag holder is mounted on said inner incontinence fecal bag holder moving device, and can be moved up or down by said inner incontinence fecal bag holder moving device;
c) said inner incontinence fecal bag is a flexible plastic bag and can be attached to or removed from said inner incontinence fecal bag holder by an inner incontinence fecal bag fastener, said inner incontinence fecal bag is capable of holding liquid waste, odor from said inner incontinence fecal bag is sealed by said incontinence bidet seat plate and said incontinence fecal tube cover;
d) said outer incontinence fecal bag holder is larger than said inner incontinence fecal bag holder and said bidet hole, the top of said outer incontinence fecal bag holder is affixed to the bottom of said top panel;
e) said outer incontinence fecal bag is a flexible plastic bag and is larger than said inner incontinence fecal bag, said outer incontinence fecal bag can be attached to or removed from said outer incontinence fecal bag holder by an outer incontinence fecal bag fastener, and is capable of holding liquid waste;
such that excrement and cleaning water that fall through the gap between said incontinence bidet seat and said top panel is collected in said outer incontinence fecal bag;
f) said incontinence cleaning device is capable of washing and drying the private part of an user and said incontinence bidet seat pad, said incontinence cleaning device is connected to said incontinence water tank via a water tube and get water supply from said incontinence water tank;
g) said butt retainer is briefs like and is preferably made of water proof fabric, said butt retainer is installed above said bidet hole, said butt retainer has a bottom opening, the edge of said bottom opening can be attached to or removed from the edge of said bidet hole by a retainer fastener, a retainer cleaning hole is opened on top of said butt retainer to allow caregiver to insert washing tube or dryer tube into said butt retainer for cleaning and drying, said butt retainer can be divided into several pieces for easy setup and cleaning;
wherein the size of said butt retainer is large enough for an user to sit up or turn over freely in said care equipment;
such that when an user wear said butt retainer, said user's butt is retained above said incontinence bidet seat, and said user is still free to sit up or turn over in bed;
such that when an user defecates, said fecal sensor detects the feces and sends a signal to order said inner incontinence fecal bag holder moving device to lower said inner incontinence fecal bag holder, thus move said incontinence bidet seat pad out of said bidet hole, at the same time to order said fecal tube cover opening device to open said fecal tube cover to allow feces drop into said inner fecal bag;
such that after a preset time, the washing unit and drying unit of said cleaning device move in to wash and dry said user's private part and said bidet seat pad, waste water that fall through said fecal hole and said fecal tube is collected in said inner incontinence fecal bag, waste water that fall through the gap between said incontinence bidet seat and said bidet hole fall is collected in said outer incontinence fecal bag;
such that after user's private part and said bidet seat pad are washed and dried, said inner incontinence fecal bag holder is moved up by said inner incontinence fecal bag holder moving device, such that said incontinence bidet seat pad is pushed into said bidet hole to reposition.
